(19) United States
(12) Patent Application Publication
(10) Pub. No.: US 2025/0295110 A1
(43) Pub. Date: Sep. 25, 2025

(54) IMPROVED FORMULATIONS FOR OXIDATION, BLEACHING AND MICROBIAL CONTROL

(71) Applicant: Clean Chemistry, Inc., Boulder, CO (US)

(72) Inventors: Wayne E. BUSCHMANN, Boulder, CO (US); Carl R. EVENSON, Erie, CO (US)

(21) Appl. No.: 18/709,869

(22) PCT Filed: Nov. 17, 2022
(86) PCT No.: PCT/US2022/050317

§ 371 Date: May 14, 2024

Related U.S. Application Data
(60) Provisional application No. 63/280,479, filed on Nov. 17, 2021.

(51) Int. Cl. A01P 1/00; A01N 37/16

(52) U.S. Cl. CPC A01N 37/16; A01P 1/00

(57) ABSTRACT

Peracid salt compositions are prepared from acyl donor, hydrogen peroxide and alkali metal hydroxide under controlled conditions to provide nonequilibrium compositions at high product yield from input feedstocks. The prepared nonequilibrium compositions are surprisingly stable for beneficial employment to generate reactive oxygen species, and particularly singlet oxygen, during oxidation treatments.

### REFERENCE TO RELATED APPLICATIONS

This application claims benefit of prior U.S. provisional patent application No. 63/280,479 entitled “IMPROVED FORMULATIONS FOR OXIDATION, BLEACHING AND MICROBIAL CONTROL” filed Nov. 17, 2021, the entire contents of which are incorporated herein by reference for all purposes.

### FIELD OF THE INVENTION

This invention relates to formulation improvements and methods of generating peracid salt-ROS formulations, including peracetate-ROS formulations.

### BACKGROUND OF THE INVENTION

The use of reactive oxygen species (ROS) for oxidation, bleaching and microbial control applications are commercially useful as effective, safer and more environmentally friendly alternatives to halogen-based oxidants.

Reactive oxygen species (ROS) refers to multiple forms or energy states of oxygen with greater activity or reactivity than molecular oxygen, O₂, present in air. Several ROS are found naturally occurring in the environment, play critical roles in biological systems, and have been harnessed for commercial uses. Common examples of ROS include hydroxyl radical (HO^{·}), hydroperoxyl radical (HOO^{·}), superoxide radical anion (O₂^{·}—), singlet oxygen (¹O₂), and ozone (O₃). In general, ROS in water are short-lived and, for commercial uses, are generated at the point of use or in-situ.

Each ROS has a different oxidation potential and reactivity profile making them useful in different situations. The most powerful, but shortest-lived, ROS in water treatment conditions is the hydroxyl radical, which is useful for breaking down most chemical contaminants as non-selective oxidizer and is readily produced by in-situ chemical catalysis or photolysis methods. However, the hydroxyl radical reacts very rapidly with salts, carbonate, peroxide and itself which greatly reduces its efficiency, especially in saline water. At the other end of the oxidative strength spectrum is superoxide, which can selectively oxidize or reduce specific materials and is an important intermediate in catalytic cycles (e.g., Fenton) and cellular chemistry. Singlet oxygen is of interest for its selective oxidative reactivity and biocidal properties compared to other ROS, especially in the presence of salts, water treatment chemicals, cellulose and textiles.

Oxygen in the earth's troposphere normally exists in its electronic “ground state,” technically referred to as triplet molecular oxygen, having two unpaired electrons (di-radical) in orthogonal, non-bonding orbitals and is commonly abbreviated as ³O₂. When the unpaired electrons are paired up in a higher energy, excited state known as singlet molecular oxygen, ¹O₂, it exhibits unique chemical reactivity compared to the ground state. Singlet oxygen has a brief lifetime of a few microseconds in water before it returns to the ground state.

Singlet oxygen has often been examined for its use in selective oxidation reactions, microbial control, and triggering tumor cell death by using dye-sensitized photooxidation methods to generate singlet oxygen in gas or liquid phases. However, practical methods of producing singlet oxygen for large scale applications without the need for color dyes and illumination in a process has limited its use to small-scale specialty applications such as photodynamic therapy.

A variety of chemical generation methods have been examined to produce singlet oxygen in the absence of illumination. These methods generally involve the combination of oxygen atoms associated with a “parent” molecular structure, which are released as molecular oxygen in the singlet electronic state as a byproduct of specific thermochemical reactions or transformations of the “parent” molecular structure. For example, the rapid reaction between hydrogen peroxide and sodium hypochlorite is a commonly known chemical approach to produce singlet oxygen in moderate yield at the expense of the ingredients. However, the reaction is too fast and too brief for practical use formulated as a liquid concentrate. This approach also introduces free chlorine into a process, which rapidly produces toxic chlorinated byproducts and elevates corrosivity. In fact, hydrogen peroxide is used commercially as an industrial chlorine quenching agent.

A controlled reaction of peroxides in liquid formulations is a preferred approach to produce singlet oxygen in high yield and on a time scale that allows it to be applied in a variety of use environments. This approach is now known to provide safety and environmental benefits over other approaches including the above examples while being practical for a wide variety of uses and use environments. Developing better methods of producing peroxide formulations and their reactive oxygen generating properties are essential to controlling chemical activity, technical performance, and working time in which to apply the chemistry. To be industrially useful the production of such a formulation must be done efficiently and cost-effectively on a large scale.

Methods to produce activated peracetate-ROS formulations on-demand that are suitable for generating ROS, especially singlet oxygen, were recently disclosed. These activated formulations provide enhanced oxidative power and microbial control performance relative to stabilized peracetic acid formulations containing significant concentrations of hydrogen peroxide, acetic acid, and peroxide stabilizers. The activated peracetate-ROS formulations are moderately alkaline, low odor and reduce chemical vapor exposure hazards in the workplace.

Previously disclosed peracetate-ROS formulations, such as those disclosed for example in WO 2014/039929 A1 or US 2016/0068417 A1, were produced by reaction of an alkaline hydrogen peroxide source with an acetyl donor material in a process that used a large molar excess of acetyl donor groups relative to hydrogen peroxide to ensure virtually all of the hydrogen peroxide was consumed rapidly such that the concentration of residual hydrogen peroxide would be at a low level, such as less than 3% the mass of the peracetic acid/peracetate concentration, and to minimize competing side-reactions that decrease the yield and concentration of peracetate in the product solution. The use of peroxide stabilizers must also be excluded to avoid blocking reactions that produce ROS.

The generating of peracetate-ROS formulations rapidly with little to no hydrogen peroxide residual are required conditions for efficient singlet oxygen production without the quenching of singlet oxygen activity by hydrogen peroxide and preventing side-reactions that reduced peracetate production efficiency and product concentration.

To achieve these conditions previously, a substantial excess of acetyl donor groups was used to accelerate a reaction at alkaline pH which consumed hydrogen peroxide and formed peracetate at a rate that minimized the extent that derogatory side reactions could occur. Formulations made by this method have been demonstrated to be commercially useful as practical, safer, less corrosive and less toxic alternatives to a variety of commercial products with examples including chlorine, hypohalites, chlorine dioxide and peracetic acid.

A specific challenge of the previously disclosed approach was the scale up of a production process that could operate efficiently with respect to feedstock utilization to make the preferred peracetate-ROS product composition. In previous work it was found that as the molar excess of acetyl donor groups were reduced relative to hydrogen peroxide, the desired reaction to produce peracetate would slow down relative to the rate of side reactions that reduce production efficiency, product concentration, and working time of peracetate-ROS formulations. At the same time, an increase in acetyl donor material in a production process or in the peracetate product generated in a production process can lead to other potential side reactions that result in reduced production efficiency, concentration, and working time of peracetate-ROS formulations.

In prior work, optimizing production process controls and production system design (i.e., engineering methods) could improve the accuracy of the process to generate a more consistent product. However, these engineering methods of optimization could not overcome inherent limitations of the chemistry during production of peracetate-ROS formulations at larger scales suitable for larger commercial uses.

It is desirable to develop improved peracetate-ROS formulations and methods of generating these formulations at a large scale.

### SUMMARY OF INVENTION

This invention provides new peracid salt-ROS formulations and new methods of generating peracid salt-ROS formulations, with preferred formulations of the invention being peracetate-ROS formulations. The peracid salt-ROS formulations are nonequilibrium peracid salt compositions capable of generating ROS, and especially singlet oxygen, during use in oxidation treatments. With the present invention, it was discovered that changing the chemical feedstock ratios and initially formed product formulation to outside the ranges taught in prior art results in significant improvements to methods of generating peracetate-ROS formulations at larger production scales made by batch, semi-continuous or continuous process methods. Improvements over prior art generally include: higher production efficiency while using less acetyl donor material; more consistent product characteristics between production batches or cycles; increased working time to apply the chemistry; and lower byproduct residuals of the chemistry.

As will be appreciated, peracetic acid is one of several peracids, which are also referred to as peroxyacids. The discussions below and in the appended claims are presented primarily by reference to peracid salt-ROS formulations based on peracetic acid, which are referred to herein generally as peracetate-ROS formulations, but the principles discussed are thought to apply to peracid salt-ROS formulations based on other organic peracids, with replacement of peracetate with the corresponding salt form of an organic peracid other than peracetic acid. The peracid salt-ROS formulations, including peracetate-ROS formulations are preferably in the salt form with an alkali metal salt, preferably sodium and/or potassium, and more preferably sodium. Discussion in the description below and the appended claims to sodium apply also to formulations including potassium instead. Peracid salt-ROS formulations are also referred to as peracid-reactive oxygen species formulations and peracetate-ROS formulations are also referred to as peracetate-reactive oxygen species formulations.

This invention provides methods for producing peracetate-ROS formulations with a substantially reduced excess of acetyl donor material that more closely approaches a stoichiometric 1:1 ratio of hydrogen peroxide to acetyl donor groups relative to prior art preparation methods while maintaining or increasing the production efficiency of an active peracetate-ROS formulation. This invention provides peracetate-ROS formulations having advantageous properties, and which may be prepared by the noted method.

This invention reduces material consumption and associated costs for producing peracetate-ROS formulations compared to previous methods.

This invention provides methods to produce peracetate-ROS formulations with enhanced compositional and performance characteristics with greater consistency of prepared formulations than previous methods in batch, semi-continuous and continuous production processes for large scale commercial uses.

This invention provides an improved peracetate-ROS formulation that increases working time at an elevated concentration range prior to its use or dilution to a point of use concentration.

This invention provides a peracetate-ROS formulation that contains less total organic carbon (TOC) from product residues compared to previous formulations. Further this formulation has less TOC compared to equilibrium peracetic acid products.

The improvements were enabled by the discovery of a previously unknown “threshold” for the amount of excess acetyl donor relative to hydrogen peroxide as the excess acetyl donor used to prepare the peracetate ROS formulation at a high pH is reduced closer to a stoichiometric molar ratio of acetyl donor groups to hydrogen peroxide, below which threshold there was an abrupt change in reaction behavior such that undesirable side reactions were significantly and unexpectedly reduced relative to the desired reaction to form peracetate at high efficiency and with the preferred composition optimized to generate singlet oxygen. It was discovered that changing the chemical feedstock ratios to outside the ranges taught in prior art resulted in an unexpected, disproportionate change and improvement to the peracetate-ROS formulations and efficiency of preparation performance.

In previous work concerning generation of peracetate-ROS formulations, two parameters were used to control generation of the formulations, specifically the ratio of alkali to hydrogen peroxide and the hydrogen peroxide to acetyl donor ratio. Previously these ratios were presented as the ratio of hydrogen peroxide to alkali in the range of 1:1.2 to 1:2.5, now presented as alkali to hydrogen peroxide having a range of 1.2:1 to 2.5:1 and the hydrogen peroxide to acetyl donor ranges presented formerly as from 1:1.25 to 1:4, currently presented as ranging from 0.80:1 to 0.25:1. In this reaction a significant molar excess of acetyl donor over alkaline hydrogen peroxide is required to provide efficient conversion of hydrogen peroxide, the limiting reagent, to peracetate before other side reactions that reduce production efficiency become significant (e.g., less than about 88% hydrogen peroxide to peracetate conversion yield). This reaction is driven by the excess of acetyl donor.

In contrast, in the present invention three parameters are identified as critical to approach stoichiometric hydrogen peroxide to acetyl donor molar ratios for generation of peracetate-ROS formulations with more efficient use of acetyl donor and less reaction byproducts which can be quantified as total organic carbon. The primary controlling parameters are the alkali to acetyl donor ratio and the hydrogen peroxide to acetyl donor ratio. The alkali to hydrogen peroxide ratio is dependent on, and a result of, the first two controlling parameters. These controlling parameters were discovered to be of critical importance for the efficient production of singlet oxygen producing peracetate solutions approaching stoichiometric hydrogen peroxide to acetyl donor molar ratios (i.e., 0.80:1 to 1.0:1). This approach minimizes undesirable side reactions that reduce peracetate yield and short-term stability.

The importance of the alkali to acetyl donor molar ratio is not obvious due to its indirect relationship with product concentration, yield and stability when the acetyl donor is in significant stoichiometric excess over hydrogen peroxide and the peracetate product as disclosed in prior art. Scale up was not commercially feasible previously when using a large excess of acetyl donor material because a very large excess of sodium hydroxide over hydrogen peroxide leads to competing consumption of acetyl donor by sodium hydroxide, loss of product yield and pH outside of the previously specified range. However, the alkali to acetyl donor molar ratio discovered in the present invention provides systematic control of the yield and compositional parameters of the produced peracetate solutions when approaching stoichiometric equivalence to the peracetate product. The alkali to hydrogen peroxide ratio is dependent on, and a result of, the first two controlling parameters. The hierarchy of these parameters can be listed as 1) NaOH:acetyl donor molar ratio, 2) hydrogen peroxide:acetyl donor molar ratio and 3) NaOH:hydrogen peroxide molar ratio.

The present invention provides compositions and methods of producing a peracetate solution by a near-stoichiometric reaction between hydrogen peroxide and an acetyl donor capable of efficiently producing singlet oxygen, has improved short-term stability for improved working time, and can be used in the presence of acidulants and near-neutral pH buffered environments without significant loss to degradation reactions. A method of producing a peracetate solution using a molar ratio of alkali as sodium hydroxide to acetyl donor in a range of 1:1 to 1.3:1 combined with a molar ratio of hydrogen peroxide to acetyl donor in a range of 0.8:1 to 1:1 and where the preferred peracetate solution pH range is 12.5 to 13.5 when first made and where the peracetate concentration in solution is 1% to 8% and the residual hydrogen peroxide concentration is zero to 1400 mg/L.

One aspect of this disclosure is directed to aqueous, nonequilibrium peracetate compositions for generation of singlet oxygen for use in oxidative treatments. Such a nonequilibrium peracetate composition can comprise:
dissolved peracid anion of an alkali metal salt of a peracid at a concentration in a range of from 1.0% (weight/volume) to 8.0% (weight/volume);
pH in a range of from pH 12.0 to pH 13.5;
a concentration of dissolved hydrogen peroxide of no more than 1400 mg/L;
a 10-minute stability index (SI₁₀) at a temperature of 22° C. of at least 0.80, wherein the 10-minute stability index is calculated according to Equation I:

$$S {I}_{10} = C {A}_{10} / {CA}_{0} \qquad Equation I$$

wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

Another aspect of this disclosure is directed to a methods for preparing a nonequilibrium peracid salt composition in relatively stable form for short-term storage and handling prior to use to generate singlet oxygen during oxidative treatments. Such a method can comprise:
reacting components in an aqueous reaction mixture prepared from a combination of chemical feedstocks to form an aqueous nonequilibrium peracid salt composition, the chemical feedstocks comprising acyl donor, hydrogen peroxide and alkali metal hydroxide in amounts and proportions, including to account for yield losses, to prepare the nonequilibrium peracid salt composition with composition properties comprising:
   dissolved peracid anion of the peracid salt at a concentration in a range of from 1.0% (weight/volume) to 8.0% (weight/volume); and
   pH in a range of from pH 12.0 to pH 13.5; and
wherein the combination of reaction feedstocks comprises:
   a first molar ratio of the alkali metal hydroxide to the acyl donor in a range of from 0.95 to 1.40; and
   a second molar ratio of hydrogen peroxide to the acyl donor in a range of from 0.80 to 1.10; and
continuing the reacting at least until the nonequilibrium peracid salt composition is prepared including the composition properties.

Another aspect of this disclosure are directed to methods and uses of oxidative treatments of substrates. Such a method or use can comprise contacting the substrate with a nonequilibrium peracid salt composition, for example of the previously noted aspect.

These and other aspects of this disclosure are subject to various refinements and enhancements as discussed herein, including in the section below titled “Example Implementation Combinations” and in the appended claims, and as illustrated in the drawings.

### BRIEF DESCRIPTION OF THE DRAWINGS

FIG. 1 shows a graph comparison of pH, peracetic acid concentration and acetyl donor groups to hydrogen peroxide ratios of the formulation vs prior art.

### DETAILED DESCRIPTION

### Definitions

Unless defined otherwise, all technical and scientific terms used herein have the same meaning as commonly understood by one of ordinary skill in the art.

The term “reactive oxygen species” as used herein generally refers to a species such as may include singlet oxygen (¹O₂), superoxide radical (O₂^{·-}), hydroperoxyl radical (HOO^{·}), hydroxyl radical (HO^{·}), acyloxy radical (RC(O)—O^{·}), and other activated or modified forms of ozone (e.g., ozonides and hydrogen trioxide). Each of these ROS has its own oxidation potential, reactivity/compatibility profile, compatibility/selectivity and half-lives.

The term “acyl group”, as used herein, is a —C(O)R′ group, where R is generally a hydrocarbon-based group and more specifically is an alkyl group, or aryl group (e.g., phenyl or benzyl). An acetyl group is a type of acyl group where R′ is a methyl group, i.e., —C(O)CH₃. An “acyl donor”, particularly an “acetyl donor”, functions to transfer an acyl or particularly an acetyl group, respectively, to another chemical species. “Acyl Donor” includes, but is not limited to, an acetyl donor chosen from the group including: monoacetin, diacetin, triacetin (TA), acetylsalicylic acid, and tetraacetylethylenediamine (TAED). “Acyl donor” refers to a material that provides an acyl group for preparation of the peracetate-ROS formulations whereas “acyl donor group” refers to an acyl group on an acyl donor that is available on the acyl donor material to be transfer for preparation of the peracetate-ROS formulation.

The term “alkali” or “alkali concentrate” includes any alkali material. In a preferred embodiment, alkali is an aqueous sodium hydroxide solution, or an aqueous potassium hydroxide solution.

The term ‘acidulants” includes any acid used to impart acidity to a substrate. Nonlimiting examples of acids useful in the invention may include: hydrochloric, sulfuric, acetic, formic, lactic, citric, malic, and other acids. Acids may be inorganic or organic acids. By substrate is meant any feature to which an acidulant may be applied to impart acidity to the substrate, such as for example solid object surfaces, particulates and liquids.

The term “byproducts” means any additional substance that results from a chemical reaction. Byproducts may be useful as co-solvents, pH buffers, chelating agents or stabilizers. For example, the byproduct of monoacetin, diacetin and triacetin is glycerol, a potential co-solvent that is readily biodegradable. Another example is the byproduct of TAED (tetraacetylethylenediamine) which is DAED (diacetylethylenediamine), which can act as a chelating agent for transition metal ions and potentially serve as a peroxide stabilizer. Another example of a byproduct is the carboxylic acid produced after a peracid reacts with a material in a chemical oxidation process or decomposes. Acetic acid, a byproduct of peroxyacetic acid, can serve as a co-solvent, an acidulant, a pH buffer, and a chelating agent.

References to peracid concentration (e.g., peracetate concentration) are to the concentration of the peracid anion (e.g., peracetate anion) component of the peracid salt (e.g. peracetate salt), that is excluding the mass of the metal component (e.g., sodium, potassium) of the peracid salt, on a weight/volume ratio, that is a weight (or mass) of the peracid anion to the total volume of the formulation. As will be appreciated, when a peracid-based formulation comprises the peracid component primarily in the form of a conjugate base (e.g., peracetate anion for peracetic acid-based formulation) as is the case with peracid salt-ROS formulations discussed herein having a very large molar ratio of peracid anion (e.g., peracetate anion) to peracid (e.g., peracetic acid), such as for example 10,000:1 or larger, a weight/volume concentration of the formulation measured in terms of an equivalent amount of peracetic acid will be close to the concentration of the peracid anion, and needs to be adjusted only to remove the mass of a dissociated proton.

The present invention involves improved peracetate-ROS formulations, and methods of making peracetate-ROS formulations, capable of producing significant quantities of reactive oxygen species, including singlet oxygen. An unexpected finding enabling the improvements was the discovery of the noted “threshold” where there was an abrupt change and improvement in product production efficiency and characteristics of the product solution's behavior/properties as the molar ratio of hydrogen peroxide:acetyl donor was reduced toward 1:1 when making peracetate-ROS formulations at a high pH. The threshold appeared to be at a molar ratio of around 1:1.20 to 1:1.25. This finding is in contrast to the teachings of prior art where a more substantial excess of acetyl donor was disclosed (i.e., hydrogen peroxide:acetyl donor groups molar ratio of 1:1.25 to 1:4) to make the peracetate formulation and generally with formula preparation at lower alkaline pH's at the lower end of this prior art range.

In some embodiments the peracetate-reactive oxygen species formulation has a very alkaline pH as prepared, with the pH in a range having a lower limit selected from the group consisting of about pH 12.2, about pH 12.3, about pH 12.4 and about pH 12.5 and having an upper limit selected from the group consisting of about pH 13.5, about pH 13.2, about pH 13.0 and about pH 12.9, and with one preferred range being from about 12.5 to about 13.5 and with another preferred range being from pH 12.5 to pH 12.9. As will be appreciated, the peracid-reactive oxygen species formulations are typically aqueous compositions. Also as will be appreciated, the peracetate-reactive oxygen species formulations will be non-equilibrium compositions that will degrade over time. However, the combination of very alkaline pHs with minimal excess acyl donor groups at which the peracetate-reactive oxygen species formulations are prepared provide advantages of contributing to reduction of side reactions during preparation and slower degradation of the non-equilibrium composition until the non-equilibrium composition is subjected to a lower-pH environment, for example as would be the case when added to a liquid composition to be treated that is at a lower pH, or is contacted with a solid object surface to be treated.

In some embodiments the peracetate-ROS formulation has a peracid anion to peracid molar ratio in a range having a lower limit selected from the group consisting of about 10,000:1, about 15,000:1 and about 18,000:1 and an upper limit selected from the group consisting of about 40,000:1 and about 38,000:1. One preferred range is from 15,000 to 40,000, and a more preferred range is from 18,000 to 38,000. In one a preferred embodiment the peracid anion to peracid ratio is from about 18,970:1 to about 37,880:1. This ratio of peracid anion to peracid enables a preferred calculated pH range of about 12.5 to about 12.8 for the peracetate-ROS formulation of the present invention.

In some embodiments an alkali hydrogen peroxide solution is generated using a molar ratio of hydrogen peroxide to alkali in the range having an upper limit selected from the group consisting of 1:0.8, 1:0.9 and 1:1.0 and a lower limit selected from the group consisting of 1:1.5, 1:1.3, 1:1.2 and 1:1.18, and with one preferred range being from 1:1.0 to 1:1.2 and another preferred range being from 1:1.0 to 1:1.18.

In some embodiments the peracid salt-ROS formulation is produced by mixing the alkali hydrogen peroxide solution with an acyl donor such that the molar ratio of hydrogen peroxide to acyl donor groups, and preferably acetyl donor groups, is in a range of having a first limit (upper limit) selected from the group consisting of 1:1.0, 1:1.05, 1:1.08 or 1:1.10 and a second limit (lower limit) selected from the group consisting of 1:1.25, 1.23, 1.20, or 1.18, with one preferred range being from 1:1.0 to 1:1.23, another preferred range being from 1.1.0 to 1:1.20, yet another preferred range being from 1:1.05 (and more preferably from 1:1.08) to a selected upper limit and preferably the selected upper limit is 1.123, more preferably 1.120 and even more preferably 1.18. Any ratios described herein can be alternatively stated simply as the decimal quotient value for the ratio. For example, a ratio of 1:1.10 could alternatively be stated as 0.91 (the quotient of 1/1.10). Also, some ratios are discussed herein in an alternative format with the components of the ratios reversed, and for which the quotient value will be a reciprocal value. For example, the discussion below includes references to the molar ratio of hydrogen peroxide to acyl donor groups. As one example, a molar ratio of acyl donor to hydrogen peroxide of 1.20:1 (or more simply stated as a quotient value of 1.20) is the same as a molar ratio of hydrogen peroxide to acyl donor of 0.83:1 (or more simply stated as a quotient value of 0.83).

In some embodiments the peracetate-ROS formulation has a molar ratio of peracid anions, preferably peracetate anions, to hydrogen peroxide of greater than about 16:1.

In some embodiments a peracetate-ROS formulation, which may be considered to be in the form of a prepared concentrate, is produced with a peracetate concentration (on a peracetate basis, excluding the salt metal such as sodium or potassium) in a range having a lower limit selected from the group consisting of about 1.0% wt/vol, about 2.0% wt/vol and about 3.0% wt/vol and an upper limit selected from the group consisting of about 8.0% wt/vol, about 6.0% wt/vol and about 5% wt/vol, with one preferred concentration range being from about 2.0 wt/vol to about 6.0% wt/vol and a more preferred concentration range being from about 3.0% wt/vol to about 5% wt/vol.

In some embodiments the acyl donor is an acetyl donor, with one preferred acetyl donor being triacetin. Although much of the description herein is presented in terms of acetyl donor, the same principles apply to other acyl donors.

In some embodiments the hydrogen peroxide in the formulation is no more than, and preferably less than, 10 mg/l. The limit for level of detection for hydrogen peroxide is 10 mg/L by one common hydrogen peroxide analysis technique.

In some embodiments the production efficiency in this new formulation can be defined as the efficiency of hydrogen peroxide use and/or efficiency of triacetin use relative to the theoretical limit of complete conversion to peracetic acid of a stoichiometric molar feed ratio of hydrogen peroxide to acetyl donor groups of 1:1 (which equates to a molar ratio of hydrogen peroxide to triacetin of 1:0.33 when triacetin is used to provide the acetyl donor groups). For example, peracetate may be made at a 98% conversion efficiency of hydrogen peroxide and 90% conversion efficiency of triacetin. However, this is not a limitation on the molar ratio ranges of ingredients or the product formulation. One very useful measure for evaluating production efficiency with the present invention is the conversion efficiency of hydrogen peroxide to peracetate, since the hydrogen peroxide will typically be provided in an amount equal to or no larger than, and more typically somewhat smaller than, a stoichiometric amount relative to acetyl donor groups. Under conditions with a stoichiometric or molar deficiency of hydrogen peroxide, 100% conversion efficiency of hydrogen peroxide to peracetate represents a maximum theoretical conversion efficiency, regardless of the magnitude of the molar excess of acetyl donor used. Surprisingly, and unexpectedly, the conversion efficiency of hydrogen peroxide is seen to increase even as the molar excess of acetyl donor is decreased to below a threshold molar ratio, and this surprising and unexpected result is thought to be a consequence of a marked reduction in side reactions that result in a lower yield of peracetate relative to the feed of hydrogen peroxide. In this respect, the amount of peracetate in a prepared peracetate ROS formulation is determined as an equivalent quantity of peracetic acid.

In some embodiments the alkali:acetyl donor groups ratio is at least 1:1, and preferably somewhat larger than 1:1, on a molar basis, and preferably the alkali is sodium hydroxide.

In some embodiments, the levels of total organic carbon (TOC), biochemical oxygen demand (BOD) and chemical oxygen demand (COD) of this new formulation are lower than the original range described in the prior art and is also an advantage over equilibrium peracetic acid.

In some embodiments the mass of chemical ingredients for generating the new formulation range is lower than the ranges found in the prior art. For example, the hydrogen peroxide:triacetin ratio of the prior art used 2.37 to 5.19 lbs chemical feeds (100% basis) to produce 1.0 lb of peracetic acid equivalents (excluding the sodium). In contrast, the hydrogen peroxide:triacetin ratio of the present invention uses 2.00 to 2.25 lbs chemical feeds (100% basis) to produce 1.0 lb of peracetic acid equivalents (excluding the sodium). For comparison, equilibrium peracetic acid uses approximately 4.75 lbs chemical feeds (100% basis) per pound of peracetic acid. Some advantages associated with the chemistry of the peracetate ROS formulation and preparation method of the present invention are lower material, transportation and storage costs associated with smaller chemical feedstock quantities and increased safety from having less chemicals brought to and handled at a facility.

In some embodiments the improvements to the chemistry formulations used to produce the peracetate-ROS formulation of this invention enable the reliable production at high efficiency and large scale for industrial uses by batch, semi-continuous, or continuous process methods. The improved method provides stoichiometric, or nearly stoichiometric, use of the acetyl donor groups relative to hydrogen peroxide. The most material-efficient and cost-efficient hydrogen peroxide:acetyl group molar ratio is 1:1 and reaching this ratio was achieved in practice while maintaining high production efficiency, minimal hydrogen peroxide residual, and high ROS activity. The improvements have led to the development of a peracetate-ROS formulation that is different in composition to prior art and provides several benefits over the prior art.

Technical improvements and benefits of the improved formulations include:
Higher production efficiency achieved with low excess acetyl donor use.
More consistent and increased stability of product for maintaining product concentration before it decreases below the LCL (lower concentration limit) for biocidal uses.
Increased consistency of production processes to generate peracetate-ROS product formulations regarding output concentration, production efficiency, pH, and degradation rate.
Lower total organic carbon (TOC) levels in the product than previous formulation range of the prior art.

In some embodiments enhancing the peracetate product formulation with additives can be achieved with greater precision. This is due to greater purity of the peracetate product and elimination of excess hydrolysis reactions producing acetic acid and glycerin. This is a more “pure” sodium peracetate solution than prior art approaches.

In some embodiments adding triacetin after producing peracetate solution is a method for slowly producing acetic acid without degrading the peracetate concentration. This is a method for activating the peracetate solution at a moderate rate over time.

In some embodiments adding this new formulation to a media having a pH less than about 12, results in greater oxidative activity than peracetic acid according to the oxidation-reduction potential (ORP) response or technical effect. In some embodiments adding this new formulation to a media having a pH less than about 11, and more preferably having a pH less than about 10, results in greater oxidative activity than peracetic acid according to the oxidation-reduction potential (ORP) response or technical effect. In some embodiments adding this new formulation to an acidic media produces greater oxidative activity than peracetic acid according to oxidation-reduction potential (ORP) response or technical effect. This behavior is potentially relevant to bleaching, brightening and other applications such as water treatment where the ORP of a solution can be correlated with a level of biocidal control at a given pH.

The oxidative reductive potential (ORP) is a measure of how oxidizing or reducing a solution is relative to a standard reference potential measured in volts. Standard reference potentials are measured relative to the hydrogen/hydrogen ion oxidation-reduction potential of 0.000 V at unit activity for the standard hydrogen electrode (SHE). Generally, solutions with potentials greater than 0 V vs SHE are considered oxidizing (electron accepting) while solutions with potentials less than 0 V vs SHE are considered reducing (electron donating). The measured ORP of water is influenced by its pH or hydrogen ion activity. As the hydrogen ion activity (e.g., concentration) increases, the ORP of water increases to more positive values. ORP is also influenced by the presence of reducing or oxidizing agents relative to their standard reduction-oxidation potentials and solution activities.

ORP is used as a general measure of the antimicrobial strength of a solution containing an oxidizing antimicrobial agent, biocide or disinfectant. ORP may be correlated to relative oxidant concentration for lower oxidant concentrations at constant pH and temperature. This feature is the basis for ORP monitoring systems sometimes used in water treatment and disinfection processes where oxidant dose may be adjusted to maintain a desired ORP and corresponding biocidal activity for a particular oxidant. A ORP value of greater than 650 mV (vs SHE) typically indicates effective microbial control conditions when using oxidative biocide products.

A limitation of the previously described production method for the peracetate formulations was a significant loss of production efficiency when the molar ratio of hydrogen peroxide to acetyl donor groups was greater than 1:1.5 when using acetyl donor materials, especially triacetin. This loss was caused in part by the slow dissolution rate of the acetyl donor material (e.g., triacetin) in water, which can result in slowing the reaction rate with alkali hydrogen peroxide and allowing side-reactions to occur which reduced production efficiency. Using a greater excess of acetyl donor material increased the reaction rate with alkali hydrogen peroxide to increase production efficiency and minimize hydrogen peroxide residual in the product formulation. The “production efficiency” refers to the conversion efficiency of hydrogen peroxide to peracetate and represents a total measure of how effectively competing reactions are being minimized in the production process.

It was discovered in the present invention that efficiency losses were caused substantially by chemical side reactions inherent to the previous method/formulation. One side reaction between the peracetate product and excess acetyl donor material discovered in this invention is capable of reducing the pH of the reaction solution rapidly enough during the production process to cause the desired reaction between alkaline hydroperoxyl anion and acetyl groups to slow down and even stop. If the desired reaction is slowed by an excessive reduction of pH during the production process, unreacted hydrogen peroxide (in hydrogen peroxide form) will rapidly react with the peracetate anion resulting in the degradation of the peracetate product. This issue could be minimized by increasing the amount of caustic (e.g., sodium hydroxide) added to the reaction relative to the hydrogen peroxide. However, excessive amounts of caustic would also compete in the reaction with acetyl groups thereby reducing production efficiency. Thus, controlling and limiting the chemical side reactions can improve efficiency losses.

An inherent characteristic of the chemistry is that as the production efficiency decreases, the concentration of peracetate that can be produced decreases. For example, as production efficiency decreases below 90% (% hydrogen peroxide conversion to peracetate and not lost to degradative side reactions) the concentration of peracetate that can be made in the product solution decreases to less than about 3% (as PAA) and chemical feedstock consumption and cost increase significantly. A correlation has also been observed between lower production efficiency and shorter working time due to lower product stability.

In some embodiments, the residual hydrogen peroxide concentration in the peracetate-reactive oxygen species product solution is less than about 1500 mg/L, and preferably less than 750 mg/L. In some embodiments the residual hydrogen peroxide concentration in the peracetate-reactive oxygen species product solution is less than 400 mg/L and preferably less than 10 mg/L, below the level of detection.

A key aspect of this invention was discovered where a hydrogen peroxide:acetyl donor groups molar ratio of 1:1.0 to 1:1.20 (hydrogen peroxide:triacetin-molar ratio of 1:0.33 to 1:0.40) provided an abrupt change in pH behavior, production efficiency, and decay rate of the peracetate product solution in comparison to that described in prior art. The observed “threshold” of these changes can be described as a point where the amount of excess acetyl donor present in the production process is reduced to below a critical concentration where the rate of side-reactions that compete with the desired reaction between the hydroperoxyl anion and acetyl donor are reduced more than expected in proportion to incremental changes made in the production method.

Below is a listing of major competing reactions during and/or after production of a peracetate-ROS formulation and a description of each of the reactions:

HOO—+TA=>PAc—+glycerol byproduct 1.

PAc—+PAA=>OAc—+HOAc+¹O₂ 2.

PAc—+H₂O₂=>OAc—+³O₂+H₂O 3.

PAc—+TA=>HOAc+PAc—+glycerol byproduct 4.

NaOH+TA=>NaOAc+glycerol byproduct 5.

In the noted reactions, TA represents triacetin, PAc— represents peracetate anion, PAA represents peracetic acid, OAc— represents acetate anion, HOAc represents acetic acid, ¹O₂ represents singlet oxygen, ³O₂ represents triplet oxygen and NaOAc represents sodium acetate.

Reaction 1 is the desired reaction for the production of peracetate in the product solution, this is a rapid mildly exothermic reaction.

Reaction 2 is desired to produce ROS once the peracetate is made and put into use, this reaction accelerates as pH decreases into a more activated pH range of less than pH 12.

Reaction 3 occurs very rapidly when there is excess hydrogen peroxide in the presence of peracetate anion and is an exothermic reaction.

Reaction 4 was discovered in this invention to be significant in rate, however, it was not obvious because it has no direct impact on peracetate concentration or reaction mixture solution temperature.

Reaction 5 occurs at a moderately rapid rate, but is slower than reaction 1 and can be minimized by using as little excess sodium hydroxide as necessary.

Reactions 3 and 4 are the most rapid and impactful side reactions that can occur during the peracetate production process. Reaction 3 causes rapid consumption of peracetate, heating of the reaction mixture and product solution, and loss of peracetate production efficiency. Reaction 3 occurs to a significant extent if process conditions cause the rate of the desired reaction 1 to slow down or an excessive amount of hydrogen peroxide residual remains in the product solution.

Reaction 4 reduces the pH of the reaction mixture causing reaction 1 to slow and reaction 3 to accelerate resulting in loss of production efficiency and concentration. Reaction 4 can lead to a premature decrease of pH in the reaction mixture, which slows or stops the reaction to form peracetate because the hydroperoxyl anion HOO— is converted to hydrogen peroxide through its acid-base equilibrium. Additionally, as the reaction solution pH decreases, the rate of reaction 2 increases and produces more singlet oxygen at the expense of consuming peracetate, which also results in shortening the product lifetime or working time. It is desirable to not promote reaction 2 until the product solution is put into use.

Table 1 below illustrates the relative impacts of the two side reactions (reaction 2 and 3) on the degradation rate of the peracetate product. Reducing or eliminating these side reactions after the peracetate production process increases the half-life or working time of the concentrated product solution before use. Reducing or eliminating these side reactions during the peracetate production process increases feedstock conversion efficiency (production efficiency) and reduces feedstock consumption per unit of peracetate product, which results in reduced production reaction byproduct residuals and total organic (TOC) in the product solution.

TABLE 1
Comparison of pH and peracetate concentration over 60 minutes for the
peracetate-ROS formulation prepared by the new method of this invention
when left to stand at room temperature as-made and when spiked with triacetin (molar
ratio of 1:1.1 PAc⁻:acetyl donor groups) or hydrogen peroxide (molar ratio
of 1:0.57 PAc⁻:hydrogen peroxide).

| | PAc⁻ | PAc⁻ | PAc⁻ + TA | PAc⁻ + TA | PAc⁻ + HP | PAc⁻ + HP |
|---|---|---|---|---|---|---|
| | pH | Conc | pH | Conc | pH | Conc |
| T = 0 min | 12.8 | 4.50% | 10.7 | 4.50% | 11.5 | 4.50% |
| T = 60 min | 12.3 | 2.79% | 8.9 | 1.37% | 12.5 | 0.87% |

PAc⁻ + TA is an example of reaction 2 accelerated by reaction 4
PAc⁻ + HP (hydrogen peroxide) is an example of reaction 3

In this invention, important production process improvements are made to prevent the reduction in reaction rate of reaction 1, minimize the rate or occurrence of competing reactions, and prevent the buildup of unreacted acetyl donor material (triacetin) in the reaction mixture, reactor process or product working tank. What is unexpected in enabling these improvements is an abrupt change (reduction) in relative rates of competing reactions at a threshold ratio or concentration of acetyl donor (triacetin) outside the range cited in prior art while producing a peracetate solution capable of efficiently generating singlet oxygen with the characteristics described above. Although optimizing a continuous production process design and its components can compensate for some of these limitations, developing a method to better control the underlying chemical reactions is a more reliable method to improve production process efficiency and consistency.

Alkyl peroxide products used for water treatment, pulp treatment, microbial control, and sanitization applications introduce a residual level of total organic carbon (TOC) into a treated water and effluents, which can potentially be a carbon substrate supporting microbial growth and biological oxygen demand. A benefit to the present invention is that it reduces TOC significantly for an alkyl peroxide-based product compared to prior art and especially compared to equilibrium peracetic acid solutions commonly used. The production method of this invention produces peracetate-ROS solutions with a calculated TOC:peracetate anion mass ratio of 0.48 to 0.58, whereas the TOC:peracetate anion mass ratio in prior art is in the range of 0.61 to 1.9. An additional comparison is made to a common commercial grade of equilibrium peracetic acid product (15% peracetic acid, 10% hydrogen peroxide, 35% acetic acid) with a TOC:peracetic acid mass ratio of 1.2. Producing a peracetate-ROS formulation with a TOC:peracetate anion mass ratio of less than about 0.60 is a preferred advantage of the invention.

In some embodiments, a method to produce a peracetate-reactive oxygen species formulation solution capable of efficiently generating singlet oxygen with the formulation described above.

In some embodiments, a method for generating a peracetate-reactive oxygen species formulation comprising: generating an alkaline hydrogen peroxide solution having a molar ratio of hydrogen peroxide to alkali in a range having an upper limit selected from the group consisting of 1:0.8, 1:0.9 and 1:1.0 and a lower limit selected from the group consisting of 1:1.5, 1:1.3, 1:1.2 and 1:1.18, and with one preferred range being from 1:1.0 to 1:1.2 and another preferred range being from 1:1.0 to 1:1.18 of about 1:1.0 to about 1:1.2; mixing the alkaline hydrogen peroxide solution with an acetyl donor producing a peracid concentrate; the peracid concentrate generating the peracetate-reactive oxygen species formulation having a pH value from about pH 12.2 to about pH 13.5, and preferably from about 12.5 to about 13.5.

In some embodiments, a hydrogen peroxide:acyl donor groups ratio (or acetyl donor concentration) beyond a threshold where competing side reactions are reduced to rates significantly less than the reaction between hydroperoxyl anion and acetyl donor. In some embodiments this molar ratio of hydrogen peroxide to acetyl donor groups is from about 1:1.0 to about 1:1.25.

In some embodiments, a method to produce a peracetate solution formulation having a peracetate concentration of about 2% wt/vol or 5% wt/vol, wherein the production efficiency is equal to or greater than about 90% efficiency (based on hydrogen peroxide conversion to peracetate).

In some embodiments, a method to produce a peracetate solution formulation having a peracetate concentration in a range from about 3.0% wt/vol to about 8.0% wt/vol, wherein the production efficiency is equal to or greater than about 95% efficiency (based on hydrogen peroxide conversion to peracetate).

In some embodiments, a peracetate solution formulation (>2% peracetate) with peracetate concentration that decreases less than 5% of the initial concentration within 5 to 10 minutes following its production. This formulation can be used in sanitization.

In some embodiments, a peracetate solution formulation having a TOC:peracetate mass ratio of not greater than, and preferably less than, 0.60 for use in water treatment, pulp treatment, microbial control and sanitization.

In some embodiments a peracetate-ROS solution formulation is a diluted formulation that is diluted to a point of use concentration having an extended working time. A preferable extended working time can be up to 120 minutes depending on the use. Uses of the diluted formulation may include for example sanitizing solutions. In some variations of such embodiments, the diluted formulation has properties of pH, molar ratio of peracetate anion to peracetic acid, and molar ratio of peracetate anion to hydrogen peroxide as described herein for the peracetate-ROS formulations.

The new formulation can be efficiently produced in a “continuous” process as compared to the prior art feedstock ratio range wherein reducing the alkali hydrogen peroxide:triacetin molar ratio to less than 1:0.5 (a 1:1.5 hydrogen peroxide:acetyl donor groups molar ratio) did not make the desired formulation efficiently and degraded more rapidly over time.

This previous practical (ratio) limit is thought to be due to a limitation caused by the relatively low water solubility limit of the acetyl donor material (e.g., triacetin) and a slow dissolution rate into water. A slow dissolution rate allows time for undesirable competing reactions to occur that reduced the product yield and process efficiency relative to the limiting reagent, hydrogen peroxide.

However, recent work has discovered that competing side reactions can be significantly reduced in a specific formulation range outside of the formulation range taught in prior art while maintaining the most important features for singlet oxygen generation activity.

The ability to reduce the molar excess of acetyl donor groups to below 1.25 times the molar quantity of hydrogen peroxide while maintaining high conversion efficiency (≥90% relative to hydrogen peroxide consumption and losses) led to unexpected changes in behavior of the product formulation. One significant change is that the pH of the reaction process solution is maintained in a higher range than the formulation range of the prior art. During the reaction between the hydroperoxyl anion and acetyl donor group, if the pH drops too rapidly below about pH 12.2 (approaching the pKa of hydrogen peroxide of 11.6), the desired reaction slows down or stops. This new pH behavior provides a key benefit for keeping hydrogen peroxide substantially in its alkaline, anion form throughout the entire reaction period while in the presence of elevated concentrations of reactants and products. This is an advantage for preventing competing reactions which reduce production efficiency, make the product less stable, and produce higher residual total organic carbon (TOC).

For water treatment the higher pH of the product concentrate made by the new process method does not significantly impact the pH of water it is added to since there is no significant amount of NaOH in the product solution. Alkali pH of the product concentrate is due to the sodium peracetate, which is analogous to the pH effect of other weak acids, in their conjugate base forms, having pKa greater than 7 (e.g., sodium carbonate).

In some embodiments the product formulation of the new production method remains in an elevated pH range without decreasing rapidly during and after production. This new behavior led to the discovery of how peracetate can unexpectedly produce acetic acid by reaction with acetyl donor groups without consuming the peracetate in the product. The reaction between peracetate and acetyl donor groups presumably occurs by the peracetate acting as a weak nucleophile (relative to hydroxide or hydroperoxide anion), which adds to the carbonyl carbon of the acetyl group followed by displacement and water hydrolysis to form acetic acid, an alcohol byproduct of the acetyl donor molecule, and recovery of the peracetate anion.

The pH of the product solution does decrease slowly over time as a result of sodium peracetate (pKa=8.2) being consumed to form acetate and acetic acid (pKa=4.7), but not as rapidly as in the presence of excess acetyl donor groups.

In the present invention, improvements to the peracetate-ROS formulation production method and formulation solves the above disadvantages. The improved method provides stoichiometric, or nearly stoichiometric, use of the acetyl donor groups relative to hydrogen peroxide. The most material-efficiency and cost-efficient hydrogen peroxide:acetyl donor groups molar ratio is 1:1 and reaching this ratio could be achieved in practice while maintaining high production efficiency, minimal hydrogen peroxide residual, and high ROS activity. The improvements have led to the development of a peracetate-ROS product formulation that is different in composition and solution behavior after production, compared to the prior art. The improvements create a more consistent product produced from a continuous generation system regarding output concentration, production efficiency, pH, and degradation rate. A slower degradation rate was achieved for peracetate-ROS formulations of this invention, which provides a longer working time to use the chemistry or dilute the chemistry to a point of use concentration before significant loss in assay occurs.

Maintaining a high reaction rate between the hydroperoxyl anion and triacetin throughout the reaction process was critical to preventing other side reactions. Reducing the excess of triacetin used in the production process was beneficial to reducing the likelihood of this buildup occurring. Maintaining a high reaction rate between the hydroperoxyl anion and triacetin throughout the reaction process was beneficial to reducing the likelihood of the buildup occurring.

An unexpected result was obtaining a high reaction rate with triacetin in which all three acetyl donor groups reacted rapidly with HOO— to form the peracetate anion in high yield in a continuous production process. And doing so without a large excess of NaOH. This is in contrast to prior art where the reaction with triacetin was slower, requiring an excess to react quickly enough to avoid undesirable side reactions. A correlation has been made between high yield or high efficiency to produce peracetate and the product solution stability.

### EXAMPLES

### Example 1: Peracetate-ROS Formulation Production Efficiency

A peracetate-ROS formulation of the present invention was made in 500 mL “batches” with high efficiency using a minimal excess of acetyl donor to hydrogen peroxide. The formulation was made with a target peracetate concentration of 4.5% wt/vol measured as peracetic acid and an assumed production efficiency of 94% relative to hydrogen peroxide.

To three separate 1 L glass beakers containing magnetic stir bars was added 376, 378, and 380 mL (beakers 1, 2 and 3, respectively) of distilled water. The liquid contents of each beaker were stirred at a high rate for vortex mixing while 42.2 mL of 25% NaOH solution was added to each beaker. To the mixing NaOH solution in each beaker was added 57.5 mL of 17.5% hydrogen peroxide. After 60 seconds of mixing an amount of triacetin was added providing 1.0, 1.08 and 1.2 molar equivalents of acetyl donor groups relative to hydrogen peroxide, which was 19.5 mL, 21.3 mL, and 23.7 mL triacetin added to beakers 1, 2 and 3, respectively. The reaction mixture was mixed for another 60 seconds at which time the reaction was considered complete and the product solution in each beaker immediately analyzed for peracetate concentration, pH, and hydrogen peroxide residual.

Peracetate concentration was measured as peracetic acid using a standard iodometric titration method. In this method a 0.50 ml sample of the concentrated peracetate solution was diluted into about 25 mL of distilled water. To this solution was added 1 mL of an ammonium molybdate reagent (HACH part no. 193332 containing 3-7% hexaammonium heptamolybdate) followed by addition of one packet of Sulfite 1 reagent (HACH part no 220399 containing potassium iodide and starch indicator). This solution was covered and mixed gently on a magnetic stir plate for 5 minutes. The mixture was titrated to a colorless endpoint with 0.100 N sodium thiosulfate solution and the volume of titrant measured to the nearest 0.05 mL.

Residual hydrogen peroxide in the concentrated peracetate solutions was measured by selectively forming the molybdate-hydrogen peroxide complex and measuring its concentration by UV-Vis absorption spectroscopy. The absorbance value measured at 330 nm was used to determine the hydrogen peroxide concentration relative to a calibration curve of absorbance vs concentration for a series of hydrogen peroxide standard solutions at 50, 100, 200, 300 and 400 mg/L hydrogen peroxide. The indicator molybdate solution was prepared by diluting 0.40 mL of ammonium molybdate reagent (HACH part no. 193332 containing 3-7% hexaammonium heptamolybdate) to 200 mL in distilled water. The indicator molybdate solution was calibrated by measuring the 330 nm absorbance for the series of hydrogen peroxide standard solutions. Test sample preparation was designed to fill a 3.5 to 4 mL volume cuvette with 1 cm pathlength for absorbance measurement in a standard UV-Vis spectrophotometer. To prepare a sample for measurement, a 0.200 mL volume of the concentrated peracetate solution, or hydrogen peroxide standard solution, was added to 2.80 mL of the prepared molybdate indicator solution. The absorbance spectrum was measured within 2 minutes of sample preparation. The spectrum of a blank sample (distilled water added to the molybdate indicator) was subtracted from the spectra of standard solutions and unknown samples prior to obtaining the background-corrected absorbance value. The unknown hydrogen peroxide concentration was calculated from the curve fit equation for the calibration standards and the measured absorbance value. The detection limit of this procedure is approximately 10 mg/L hydrogen peroxide in 45,000 mg/L peracetate.

Using 1.00 molar equivalents of acetyl donor groups to hydrogen peroxide in the above peracetate solution preparation procedure generated a peracetate product solution concentration measured at 4.56% wt/vol as peracetic acid, with less than 10 mg/L (below detection limit) hydrogen peroxide. The solution pH was 13.0, which was measured using a high sodium pH electrode (Oakton model no. WD-35805-05). The efficiency of peracetate production relative to the amount of hydrogen peroxide used was 95%.

Using 1.08 molar equivalents of acetyl donor groups to hydrogen peroxide in the above peracetate solution preparation procedure generated a peracetate product solution concentration measured at 4.56% wt/vol as peracetic acid, with less than 10 mg/L (below detection limit) hydrogen peroxide. The solution pH was 13.0, which was measured using a high sodium pH electrode. The efficiency of peracetate production relative to the amount of hydrogen peroxide used was 95%.

Using 1.20 molar equivalents of acetyl donor groups to hydrogen peroxide in the above peracetate solution preparation procedure generated a peracetate product solution concentration measured at 4.49% wt/vol as peracetic acid, with less than 10 mg/L (below detection limit) hydrogen peroxide. The solution pH was 12.9, which was measured using a high sodium pH electrode. The efficiency of peracetate production relative to the amount of hydrogen peroxide used was 94%.

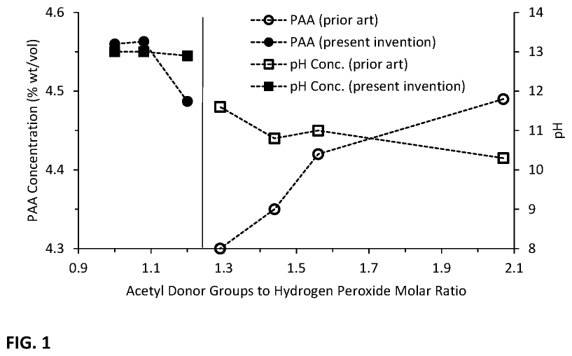

Peracetate concentration (measured as peracetic acid) and pH results described above are presented in FIG. 1 (solid symbols) where they are compared to the trends observed in prior art where peracetate production efficiency (presented as peracetic acid concentration) decreased with decreasing molar excess of acetyl donor groups relative to hydrogen peroxide. Previous trends in FIG. 1 (open symbols) assumed a production efficiency of 93% relative to hydrogen peroxide. Below about 1.5 molar equivalents of acetyl donor groups to hydrogen peroxide the production efficiency fell to less than 90% and limited the peracetate concentration that could be produced. In the present invention there is a previously unknown discontinuity in the efficiency trend below the lower acetyl donor groups:hydrogen peroxide molar ratio limit (1.25:1) taught in prior art. There is also an unexpectedly abrupt increase in solution pH below the 1.25:1 acetyl donor groups:hydrogen peroxide molar ratio.

### Example 2: Microbial Reduction in Groundwater from Storage Ponds

Reduction of microbial load in two different groundwater sources held in an open-air storage ponds. Water quality analysis of the two groundwater sources is listed in Table 2. Water parameters were measured with Oakton brand pH, ORP and conductivity sensors calibrated with standard solutions. Total iron, hardness and sulfate were measured using HACH methods 10249, 8030 and 10248, respectively, with a DR900 colorimeter. Both water sources contained elevated pH, total dissolved solids, hardness as CaCO₃, and sulfate.

Analysis of total microbial activity was measured using the LuminUltra® ATP (adenosine triphosphate) analysis method according to the manufacturer's instructions. The prepared samples were analyzed for ATP concentration using a PhotonMaster luminometer calibrated with a LuminUltra ATP standard to convert relative luminosity units (RLU) to ATP concentration as pg/mL.

Serial dilution was used for identifying and enumerating general types of acid producing bacteria, APB, and sulfate reducing bacteria, SRB. Serial dilution culture vials (Biotechnology Solutions) contained 0.5% salinity phenol red dextrose culture broth or API-RP30 culture broth. Dilution of 1 mL water sample added to 9 mL of culture broth were made according to product instructions up to a 10⁻⁶ dilution. Fungus also grew in the phenyl red dextrose media, favoring the round yeast cell form, which provided an estimate of fungal concentration.

TABLE 2
Water quality parameters of the untreated water sources.

| | Water | Water |
|---|---|---|
| Parameter | Source 1 | Source 2 |
| pH | 8.15 | 8.36 |
| ORP (mV vs SHE) | 372 | 364 |
| Conductivity (mS/cm) | 5.09 | 3.65 |
| TSS (mg/L) | 0 | 4 |
| Total Fe (mg/L) | 1.5 | 0.5 |
| Mg (mg/L as CaCO₃) | 1500 | 450 |
| Ca (mg/L CaCO₃) | 2850 | 2450 |
| Ba²⁺ (mg/L) | <1 | <1 |
| SO₄²⁻ (mg/L) | 1400 | 2400 |
| ATP (pg/mL) | 209 | 353 |
| APB (cfu/mL) | ≥10⁶ | 10⁴-10⁵ |
| SRB (cfu/mL) | 10³-10⁴ | 10³-10⁴ |
| Fungus (cfu/mL) | ≥10⁶ | 10⁴-10⁵ |

The first water source contained motile rod-shaped bacteria, spiral bacteria and filamentous bacteria morphologies as identified in microscope analysis of live samples. Fungus was present in fibril and round yeast cell forms. The second water source contained motile rod-shaped bacteria, filamentous and coccus bacteria as identified in microscope analysis of live samples. Fungus was present in fibril and round yeast cell forms. This water also contained filamentous green algae and motile single cell algae, which contributed turbidity (reported as total suspended solids, TSS) to the second water source.

Each water source was treated with the peracetate-ROS solution by adding 0.35 mL of a freshly prepared 2.0% peracetate solution to 500 mL of each water source at room temperature while mixing at 300 rpm for 2 minutes with an overhead mixer. At 60 minutes contact time the pH and ORP of the treated waters were measured and residual oxidant was quenched during microbial test sample preparation by removal (filtration for ATP) or dilution and consumption (culture media).

Test results are listed in Table 3. Following treatment, the pH of the water samples was stable. The increased ORP values suggests microbial control conditions were achieved in the samples. ATP measurements showed a rapid reduction of total microbial activity in the first 60 minutes and continued reduction over time for the treated waters stored at room temperature at 24 hours and 90 hours after treatment. Serial dilution culture vials showed the absence of culturable bacteria or fungus after the 60 minute contact time.

TABLE 3
Results of treatments with 14 mg/L peracetate treatment concentration
at 60 minutes contact time followed by 24 h and 90 h ATP tests
of the treated waters stored at room temperature.

| | Water | Water |
|---|---|---|
| Parameter | Source 1 | Source 2 |
| pH | 8.36 | 8.42 |
| ORP (mV vs SHE) | 709 | 720 |
| 60 min ATP (pg/mL) | 8.54 | 10.1 |
| 60 min APB (cfu/mL) | non-detect | non-detect |
| 60 min SRB (cfu/mL) | non-detect | non-detect |
| 24 h ATP (pg/mL) | 1.52 | 1.74 |
| 90 h ATP (pg/mL) | 0.42 | 0.97 |

### Example 3: Sanitizing Solution, Example Point of Use Sanitizing Solutions Made with Acidulant

A microbial challenge solution was made with an environmental water sample that was fortified to increase its natural bacteria population to about 10⁷-10⁸ cfu/mL. The challenge solution was made by filtering a 20 mL freshwater sample from a storage pond through a 5 micron filter to remove the majority of fungus. This was added to 980 mL of EPA AOAC hard water (US EPA SOP number MB-30-02) at 400 ppm hardness, which was fortified with 0.2 g dextrose, 0.2 g nutrient blend (5% total nitrogen, 4% phosphate, 6% potash) and adjusted to pH 7.5 with hydrochloric acid. The challenge solution was left to propagate at room temperature in aerobic conditions for 4 days before use.

The microbial challenge solution was examined by microscope analysis. Live samples showed a high density of motile bacteria, filamentous bacteria, and a very low density of fungus fibrils. Gram-stained microscope samples showed high populations of gram positive rod-shaped, round, spiral and filamentous bacteria types as well as a high density of gram negative rod-shaped bacteria. Terminal endospores were also observed.

The prepared microbial challenge solution was tested for microbial activity by adding 1 mL of challenge solution to 99 mL of AOAC hard water at pH 7.5 at room temperature and mixed briefly. Thirty seconds after mixing, culturable aerobic and heterotrophic bacteria were enumerated using dip slides with agar selective for aerobic bacteria growth (Sani-Check B, Biosan Laboratories) according to product instructions. Results showed a bacteria density of 10⁶ cfu/mL.

A first point of use sanitizing solution containing 500 mg/L peracetate was prepared by adding 1.11 mL of a freshly prepared 4.5% peracetate solution, made by the method described in Example 1, to 97.89 mL of AOAC hard water and the mixture adjusted to pH 7.5 with hydrochloric acid. To the sanitizing solution was added 1.0 mL of the microbial challenge solution and this was briefly mixed. At 30 seconds contact time the peracetate was quenched with 1.3 mL of 1N thiosulfate solution. The culturable bacteria survivors were measured using dip slide agar for aerobic and heterotrophic bacteria. Results showed culturable bacteria to be below the detection limit (less than or equal to 10 cfu/mL) demonstrating that about a 5-log reduction in culturable bacteria was achieved.

A second point of use sanitizing solution containing 500 mg/L peracetate was prepared by adding 1.11 mL of a freshly prepared 4.5% peracetate solution, made by the method described in Example 1, to 97.89 mL of AOAC hard water and the mixture adjusted to pH 7.5 with glacial acetic acid. To the sanitizing solution was added 1.0 mL of the microbial challenge solution and this was briefly mixed. At 30 seconds contact time the peracetate was quenched with 1.31 mL of 1.00 N thiosulfate solution. The culturable bacteria survivors were measured using dip slide agar for aerobic and heterotrophic bacteria. Results showed culturable bacteria to be below the detection limit (less than or equal to 10 cfu/mL) demonstrating that about a 5-log reduction in culturable bacteria was achieved.

TABLE 4
Sanitization test results in AOAC
hard water, 30 second contact time.

| | Control | Solution 1 | Solution 2 |
|---|---|---|---|
| Peracetate Conc. (mg/L) | 0 | 500 | 500 |
| Acidulant | Hydrochloric | Hydrochloric | Acetic |
| | acid | acid | acid |
| pH | 7.5 | 7.5 | 7.5 |
| Culturable bacteria (cfu/mL) | 10⁶ | ≤10 | ≤10 |

### Example 4: Formulation Testing of Near-Stoichiometric Formulation Method Targeting 4.5% Peracetate Solution

An extensive number of measurements and tests were conducted to examine the properties of a peracetate solution of mid-range concentration (4.5% w/v target concentration of peracetate) when produced by controlling the sodium hydroxide to acetyl donor molar ratio (NaOH:acetyl) and the hydrogen peroxide to acetyl donor molar ratio (HP:acetyl). The peracetate solution properties compared in this testing program include: the percent conversion of hydrogen peroxide to peracetate; the percent conversion of acyl donor to peracetate; concentration of peracetate in solution when first made (t=0), and at t=10 and t=30 minutes after that as an indication of short-term stability prior to use; the pH of the peracetate solution over time at t=0, t=10 and t=30 minutes; and the residual hydrogen peroxide concentration in the peracetate solution when first made. The stability index for the prepared nonequilibrium peracetate compositions (SI) was calculated at 10 and 30 minutes (SI₁₀ and SI₃₀). The weight ratio of total organic carbon to peracetate ratio was also calculated for the resulting peracetate compositions. The molar ratio range of NaOH:acetyl donor was varied between 0.80:1 (or simply 0.80 expressed as the quotient value of the ratio) to 1.30:1 and within each of those ranges, the molar ratio range of HP:acetyl donor was varied between 0.75:1 and 1.10:1, with some testing also done at ratios of 0.70:1 and 0.65:1. Results of this testing program is summarized in Tables 5-9, which are discussed below.

In the formulation tests, the NaOH:acetyl donor molar ratio (moles NaOH/moles acetyl donor) was varied over the range of 0.80, 0.90, 0.95, 1.00, 1.05, 1.10, 1.15, 1.20 and 1.30. For each of these ratios the HP:acetyl donor molar ratio was varied over the range of 0.75, 0.80, 0.85, 0.90, 0.95, 1.00, 1.05 and 1.10, and also for 0.65 and 0.70 for some NaOH:acetyl donor molar ratios. HP:acetyl

The formulations for analysis were made in 100 mL “batches” by the shake bottle method described below. The target concentration of 4.5% w/v peracetate (measured as peracetic acid) was made using 0.0630 moles of H₂O₂ feed, which is 6% higher than a theoretically required amount of hydrogen peroxide to prepare a targeted amount of peracetate (0.0592 moles) to make a 4.5% w/v peracetate solution, to anticipate and compensate for a typical amount of production efficiency loss, based on prior experience. Additional tests were conducted with target concentrations of 1% (0.0140 moles of feed H₂O₂), 2% (0.0280 moles of feed H₂O₂) and 8% (0.112 moles of feed H₂O₂) with the same 6% efficiency compensation above the target amount of peracetate and are discussed in Examples 5-7.

To achieve the target concentrations, the molar amount of acetyl donor was next adjusted relative to hydrogen peroxide to set the initial HP:acetyl donor molar ratio. Finally, the molar amount of sodium hydroxide was adjusted relative to acetyl donor to set the NaOH:acetyl donor molar ratio. By this procedure, the same amount of total peroxide was maintained to compare the efficiencies of converting hydrogen peroxide to peracetate. Thus, stoichiometric test conditions (molar ratio NaOH:acetyl donor, molar ratio of HP:acetyl donor and molar ratio of NaOH:HP each equal to 1.00), reagent feed was 0.0630 mole of hydrogen peroxide, 0.0210 mole of triacetin (providing 0.0630 moles of acetyl donor) and 0.0630 mole of NaOH. For non-stoichiometric test conditions, the feed amounts of acetyl donor and sodium hydroxide were adjusted to provide the desired molar ratios relative to hydrogen peroxide.

A 1:1 HP:acetyl donor molar ratio is the stoichiometric reaction ratio between these two reagents. Below the 1:1 HP:acetyl donor molar ratio hydrogen peroxide is the limiting reagent and above the 1:1 HP:acetyl donor molar ratio the acetyl donor is the is the limiting reagent. Similarly, at a 1:1 molar ratio of NaOH:acetyl donor and a 1:1 molar ratio of NaOH:HP, the sodium hydroxide is at a stoichiometric ratio with these reagents. However, the reaction rates between these three reagents in the presence of the peracetate being formed vary with their ratios and change over time as they are consumed making it not obvious how these chemical ratios control the properties of the peracetate solutions made and how an excess of one or more reagents will influence efficiency and solution properties after being made.

The shake bottle method for making a nominal 4.5% w/v solution concentration as peracetic acid having a 1:1 NaOH:acetyl donor molar ratio, a 1:1 HP:acetyl donor molar ratio and a 1:1 NaOH:HP molar ratio is as follows. Three 125 mL polyethylene bottles were labeled “A”, “B” and “C”. To bottle “A” 76.61 g of deionized water was placed into the polyethylene bottle, 7.95 mL of 25.0% NaOH was added, the composition was mixed by shaking and allowed to stand for at least 1 minute. To bottle “B” 11.51 mL of 17.5% w/w H₂O₂ was added. To bottle “C” 3.95 mL (4.58 g) of triacetin was added. The amounts of compounds added to each bottle assume 94% conversion of H₂O₂ to peracetic acid such that 4.787% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

Peracetate concentration was measured as peracetic acid using a standard iodometric titration method. In this method a 0.50 to 1.00 ml sample of the concentrated peracetate solution was diluted into about 50 mL of distilled water. To this solution was added 1 mL of an ammonium molybdate reagent (HACH part no. 193332 containing 3-7% hexaammonium heptamolybdate in dilute sulfuric acid) followed by addition of one packet of Sulfite 1 reagent (HACH part no 220399 containing potassium iodide and starch indicator). This solution was covered and mixed gently on a magnetic stir plate for 5 minutes. The mixture was titrated to a colorless endpoint with 0.100 N sodium thiosulfate solution and the volume of titrant measured to the nearest 0.05 mL. The calculation used to determine the concentration of peracetic acid are as follows:

Peracetic acid % wt/vol=[(mL thiosulfate)×(Normality of thiosulfate)×3.80]/titrated volume of peracetate solution.

Residual hydrogen peroxide in the concentrated peracetate solutions was measured by selectively forming the molybdate-hydrogen peroxide complex and measuring its concentration by UV-Vis absorption spectroscopy. The absorbance value measured at 330 nm was used to determine the hydrogen peroxide concentration relative to a calibration curve of absorbance vs concentration for a series of hydrogen peroxide standard solutions. Standard solutions were made by serial dilution of a 2500 mg/L hydrogen peroxide solution in deionized water to 1250, 625, 312.5, and 156.25 mg/L and a deionized water blank. The indicator molybdate solution was prepared by diluting 1.0 mL of ammonium molybdate reagent (HACH part no. 193332 containing 3-7% hexaammonium heptamolybdate in dilute sulfuric acid) to 100 mL in distilled water. The indicator molybdate solution was calibrated by measuring the 330 nm absorbance for the series of hydrogen peroxide standard solutions. Test sample preparation was designed to fill a 3.5 to 4 mL volume cuvette with 1 cm pathlength for absorbance measurement in a standard UV-Vis spectrophotometer. To prepare a sample for measurement, a 0.200 mL volume of the concentrated peracetate solution, or hydrogen peroxide standard solution, was added to 2.80 mL of the prepared molybdate indicator solution. The absorbance spectrum was measured within 2 minutes of sample preparation. The spectrum of a blank sample (distilled water added to the molybdate indicator) was subtracted from the spectra of standard solutions and unknown samples prior to obtaining the background-corrected absorbance value. The unknown hydrogen peroxide concentration was calculated from the curve fit equation for the calibration standards and the measured absorbance value. The detection limit of this procedure is approximately 10 mg/L hydrogen peroxide in 45,000 mg/L peracetate.

The solution pH was measured using a high sodium pH electrode (Oakton model no. WD-35805-05).

In general, increasing NaOH:acetyl donor molar ratio from upward from 1:1 (up to 1.3:1) provided an increasing trend in the percent conversion of hydrogen peroxide to peracetate, an increasing peracetate solution pH when first made, and declining percent loss of peracetate concentration 10 minutes after being made. These trends are enhanced by reducing the HP:acetyl donor molar ratio from about 1:1 lower ratios with a small molar excess of acetyl donor. Combinations of these parameters provide a preferable peracetate solution pH of about pH 12.5 and greater. The residual hydrogen peroxide concentration in the peracetate solution when first made (t=0) decreased with increasing NaOH:acetyl donor ratio and decreasing HP:acetyl donor ratio. A preferred hydrogen peroxide residual level in the peracetate formulations is less than 1400 mg/L and more preferably less than 1000 mg/L. It is important to note that when scaling up these tests towards commercial scale these trends continue and the numbers stabilize, with performance increased at the larger scale.

For a HP:acetyl donor molar ratio of greater than 1:1 (up to 1.10:1 tested) the hydrogen peroxide concentration exceeded that of the acetyl donor groups resulting in reduced hydrogen peroxide conversion efficiency, a significant concentration of residual hydrogen peroxide, and significant loss of peracetate concentration 10 minutes after production (greater than 10%) when the peracetate solution pH was less than pH 12.5 when first made.

Based on these findings, a preferred method of producing a peracetate solution capable of efficiently producing singlet oxygen in this invention uses a molar ratio of sodium hydroxide to acetyl donor of 1:1 to 1.3:1 combined with a molar ratio of hydrogen peroxide to acetyl donor of 0.8:1 to 1:1 and more preferably from 0.85:1 to 1:1. The preferred peracetate solution pH range is 12.5 to 13.5 when first made, contains less than 0.15% hydrogen peroxide residual, and exhibits a loss of 5% or less of the initial peracetate concentration at ten minutes after being made as a 4.5% peracetate solution.

Considering more specifically the results summarized in Tables 5-9, in those tables column A includes a reference number for the test conditions, column B shows the molar ratio of sodium hydroxide (alkali) to acyl donor groups (acetyl donor reactive groups of triacetin) for the different test conditions, column C shows molar ratio of hydrogen peroxide to acyl donor groups for the different test conditions, column D shows molar ratio of sodium hydroxide to hydrogen peroxide for the different test conditions, column E shows the concentration in milligrams per liter of peracetate (measured is peracetic acid) in the nonequilibrium peracetate composition as sampled from the composition as initially prepared (identified as time zero, t=0), column F shows the concentration in milligrams per liter of dissolved hydrogen peroxide in the nonequilibrium peracetate composition sampled at time zero, column G shows the calculated molar ratio of peracetate to dissolved hydrogen peroxide in the nonequilibrium peracetate composition sampled at time zero, column H shows the pH of the nonequilibrium peracetate composition sampled at time zero, column I shows the concentration in milligrams per liter of peracetate (measured as peracetic acid) in the nonequilibrium peracetate composition as sampled 10 minutes following time zero (identified as t=10), column J shows the pH of the nonequilibrium peracetate composition as sampled 10 minutes following time zero, column K shows the concentration in milligrams per liter of peracetate (measured as peracetic acid) in the nonequilibrium peracetate composition as sampled 30 minutes following time zero (identified as t=30), column L shows the pH of the nonequilibrium peracetate composition as sampled 30 minutes following time zero, column M shows the 10-minute stability index (SI₁₀) calculated as the ratio of the peracetate concentration at t=10 to the peracetate concentration at t=0 (value in column I divided by the value in column E), column N shows the 30-minute stability index (SI₃₀) calculated as the ratio of the peracetate concentration at t=30 to the peracetate concentration at t=0 (value in column K divided by value in column E), column O shows the calculated yield of peracetate in the nonequilibrium peracetate solution at t=0 relative to the feed quantity of acyl donor used to prepare the nonequilibrium peracetate solution, column N shows the calculated yield of peracetate in the nonequilibrium peracetate solution at t=0 relative to the feed quantity of hydrogen peroxide used to prepare the nonequilibrium peracetate solution, and column Q shows the calculated weight ratio of total organic carbon to peracetate in the nonequilibrium peracetate solution at t=0. Tables 10-12 summarized the same information for results of Examples 5-7, discussed below. The 10-minute stability index and the 30-minute stability index were measured on samples taken and quickly analyzed for peracetate concentration (determined as peracetic acid) after sitting in a quiescent state (without mixing) at laboratory room temperature (about 22° C.) for the noted time following taking of a time zero sample.

The results summarized in Tables 5-9 are grouped by molar ratio of sodium hydroxide to acyl donor (acetyl donor in these examples). Key measures of performance illustrated in Tables 5-9 include dissolved hydrogen peroxide levels (column F), yield of peracetate relative to acyl donor and hydrogen peroxide feedstocks (columns P and Q), short-term stability of the peracetate solution with respect to peracetate concentration over 10 and 30 minutes following initial preparation (columns M and N), initial pH of the prepared peracetate solution (column H), changes in pH that occur over 10 and 30 minutes following initial preparation (columns J and L) and total organic carbon levels in prepared peracetate solutions relative to peracetate product in the solutions. As seen in Tables 5-9, results generally improve and the range of advantageous operating conditions among different molar ratios of hydrogen peroxide to acyl donor increases as the molar ratio of sodium hydroxide to acyl donor increases from 0.80 to 1.30, although there are indications of declining performance with the molar ratio of sodium hydroxide to acyl donor at a level of 1.3 for test conditions using lower molar ratios of hydrogen peroxide to acyl donor.

It is noted that for some tests, calculated yield of peracetate relative to hydrogen peroxide or acetyl donor somewhat exceed 100%, which indicates some inaccuracy in test performance or solution analysis, as the yield of greater than 100% is not possible.

For the test conditions with a molar ratio of sodium hydroxide to acyl donor of 0.80, results are generally the worst of all molar ratios of sodium hydroxide to acyl donor tested, with best performance in that group at a molar ratio of hydrogen peroxide to acyl donor of 0.80, and even then including relatively low yield of peracetate relative to acyl donor, relatively poor short-term stability at ten and 30 minutes, and a high ratio of total organic carbon to initially-prepared peracetate.

Results for test conditions with a molar ratio of sodium hydroxide to acyl donor of 0.90 are somewhat improved. Best performance appears to be for test conditions including a molar ratio hydrogen peroxide to acyl donor of 0.90, at which the yield of peracetate relative to acyl donor is improved and total organic carbon content is reduced, but with higher hydrogen peroxide concentration and lower short-term stability over 10 and 30 minutes.

Results for test conditions with the molar ratio of sodium hydroxide to acyl donor of 0.95 show further general improvement of results, with best performance appearing to be for the test conditions with a molar ratio of hydrogen peroxide to acyl donor of 0.85, showing some improvement in the short-term stability over 10 and 30 minutes and relatively low hydrogen peroxide concentration.

Results for test conditions with the molar ratio of sodium hydroxide to acyl donor of 1.00 show further general improvement,

Results and with a band of enhanced performance for test conditions with molar ratios of hydrogen peroxide to acyl donor at 0.87 to 0.95 for test conditions with the molar ratio of sodium hydroxide to acyl donor of 1.05 show further general improvement, with a band of enhanced performance for test conditions with molar ratios of hydrogen peroxide to acyl donor from 0.85 to 0.95.

Results for test conditions with the molar ratio of sodium hydroxide to acyl donor of 1.10 and 1.15 and 1.20 further show general improvement, with a band of enhanced performance for test conditions with molar ratios of hydrogen peroxide to acyl donor from 0.85 to 0.95.

Results for test conditions with the molar ratio of sodium hydroxide to acyl donor of 1.20 also show generally improved results, and over relatively wide band of molar ratios of hydrogen peroxide to acyl donor from 0.85 to 1.00.

Results for test conditions with the molar ratio of sodium hydroxide to acyl donor of 1.30 also so generally show good results, and with some improved performance at test conditions with molar ratios of hydrogen peroxide to acyl donor at 1.05 and 1.10. It is noted however, that at the lower molar ratios of hydrogen peroxide to acyl donor of 0.80 and 0.75, results show reduced solution stability over 10 and 30 minute periods relative to similar ratios for test conditions including a molar ratio of sodium hydroxide acyl donor at 1.20. Those indications of reduced stability at those lower ratios of hydrogen peroxide acyl donor could possibly be attributable in part to reaction of excess acyl donor with sodium hydroxide through Reaction 5, noted above.

### Example 5: Determination of Near-Stoichiometric Formulation Method Targeting 1% Peracetate Solution

The production of a 1% w/v peracetate solution was targeted to demonstrate a lower production concentration in comparison to 4.5% w/v peracetate solution.

A number of measurements and tests were conducted to examine the properties of a peracetate solution (1.0% w/v target concentration) when produced by controlling the sodium hydroxide to acetyl donor molar ratio (NaOH:acetyl) and the hydrogen peroxide to acetyl donor molar ratio (HP:acetyl). The peracetate solution properties compared in this test matrix include: the percent conversion of hydrogen peroxide to peracetate; the percent conversion of acyl donor to peracetate; concentration of peracetate in solution when first made t=0, and at t=10 and t=30 minutes; the pH of the peracetate solution over time t=0, t=10 and t=30 minutes; and the residual hydrogen peroxide concentration in the peracetate solution when first made. The stability index (SI) was calculated at 10 and 30 minutes. The weight ratio of total organic carbon to peracetate ratio was also calculated. The molar ratio range of NaOH:acetyl donor was 0.80:1 to 1.3:1 and the molar ratio range of HP:acetyl donor was 0.65:1 to 1.10:1. At each of the NaOH:acetyl donor ratios the range of HP:acetyl donor ratios was produced and analyzed. This data is captured in Table 10.

In the formulation tests, the NaOH:acetyl donor molar ratio (moles NaOH/moles acetyl donor) used was 1.10. For these tests the HP:acetyl donor molar ratio was varied over the range of 0.75, 0.80, 0.85, 0.90, 0.95, 1.00, 1.05 and 1.10. This represents a test matrix of 1×8 formulations for preparation and analysis. Two individual tests were also run at 1.2 and 1.3 NaOH:acetyl donor molar ratio to 0.9 HP:acetyl donor. The ratio of NaOH:H₂O₂ was determined by experimentally following the establishment of the NaOH:acetyl and the HP:acetyl donor molar ratios for all combinations in the test matrix.

The formulations for analysis were made in 100 mL “batches” by the shake bottle method described in Example 4 except where noted. The target concentration of 1.0% w/v peracetate (measured as peracetic acid) was made using 0.0140 moles of H₂O₂, which is 6% higher than the expected amount of peracetate (0.131 moles) to compensate for a typical amount of production efficiency loss.

The shake bottle method for making a nominal 1.0% w/v solution concentration as peracetic acid having a 1:1 NaOH:acetyl donor molar ratio, a 1:1 H₂O₂:acetyl donor molar ratio and a 1:1 NaOH:H₂O₂ molar ratio is as follows. Three 125 mL polyethylene bottles were labeled “A”, “B” and “C”. To bottle “A” 55.21 g of deionized water was placed into the polyethylene bottle, 1.76 mL of 25.0% NaOH was added, the composition was mixed by shaking and allowed to stand for at least 1 minute. To bottle “B” 2.55 mL of 17.5% w/w H₂O₂ was added. To bottle “C” 39.30 g of deionized water was placed into the polyethylene bottle, 0.875 mL (1.015 g) of a triacetin was added, and the composition was mixed by shaking for at least 1 minute. The amounts of compounds added to each bottle assume 94% conversion of H₂O₂ to peracetic acid such that 1.065% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

The rest of the testing parameters including peracetate concentration, residual hydrogen peroxide measurements were performed as in Example 4.

The residual hydrogen peroxide concentration was near the upper desirable limit and this decreased conversion of the hydrogen peroxide to peracetate.

As seen in the results summarized in Table 10, preparing nonequilibrium peracetate solutions targeted at a concentration of about 1% peracetate experienced low product yield, with best results at test conditions including a molar ratio of sodium hydroxide to acyl donor of 1.1 and a molar ratio of hydrogen peroxide to acyl donor of 0.75, providing significant molar excess of acyl donor relative to hydrogen peroxide and leading to a high level of total organic carbon in the resulting peracetate product. However, based on experience, it is anticipated that better results would be obtained when operating at larger scale due to better control over mixing and product preparation conditions than in the laboratory tests with the small, 100 mL test batches.

### Example 6: Determination of Near-Stoichiometric Formulation Targeting 2% Peracetate Solution

The production of a 2% w/v peracetate solution was targeted to demonstrate a lower practical production concentration that is enabled by the above formulation approach that produces a peracetate solution at pH 12.5 or greater with at least a 90% conversion of hydrogen peroxide to peracetate and less than 1000 mg/L hydrogen peroxide residual.

A number of measurements and tests were conducted to examine the properties of a peracetate solution (2.0% w/v target concentration) when produced by controlling the sodium hydroxide to acetyl donor molar ratio (NaOH:acetyl) and the hydrogen peroxide to acetyl donor molar ratio (HP:acetyl). The peracetate solution properties compared in this test matrix include: the percent conversion of hydrogen peroxide to peracetate; the percent conversion of acyl donor to peracetate; concentration of peracetate in solution when first made t=0, and at t=10 and t=30 minutes; the pH of the peracetate solution over time t=0, t=10 and t=30 minutes; and the residual hydrogen peroxide concentration in the peracetate solution when first made. The stability index (SI) was calculated at 10 and 30 minutes. The weight ratio of total organic carbon to peracetate ratio was also calculated. The molar ratio range of NaOH:acetyl donor was 0.80:1 to 1.3:1 and the molar ratio range of HP:acetyl donor was 0.65:1 to 1.10:1. At each of the NaOH:acetyl donor ratios the range of HP:acetyl donor ratios was produced and analyzed. This data is captured in Table 11.

In the formulation tests, the NaOH:acetyl donor molar ratio (moles NaOH/moles acetyl donor) used was 1.10. For these tests the HP:acetyl donor molar ratio was varied over the range of 0.75, 0.80, 0.85, 0.90, 0.95, 1.00, 1.05 and 1.10. This represents a test matrix of 1×8 formulations for preparation and analysis. Two individual tests were also run at 1.2 and 1.3 NaOH:acetyl donor molar ratio to 0.9 HP:acetyl donor. The ratio of NaOH:H₂O₂ was determined by experimentally following the establishment of the NaOH:acetyl and the HP:acetyl donor molar ratios for all combinations in the test matrix.

The formulations for analysis were made in 100 mL “batches” by the shake bottle method described in Example 4 except where noted. The target concentration of 2.0% w/v peracetate (measured as peracetic acid) was made using 0.0280 moles of H₂O₂, which is 6% higher than the expected amount of peracetate (0.0263 moles) to compensate for a typical amount of production efficiency loss.

The shake bottle method for making a nominal 2.0% w/v solution concentration as peracetic acid having a 1:1 NaOH:acetyl donor molar ratio, a 1:1 H₂O₂:acetyl donor molar ratio and a 1:1 NaOH:H₂O₂ molar ratio is as follows. Three 125 mL polyethylene bottles were labeled “A”, “B” and “C”. To bottle “A” 89.63 g of deionized water was placed into the polyethylene bottle, 3.53 mL of 25.0% NaOH was added, the composition was mixed by shaking and allowed to stand for at least 1 minute. To bottle “B” 5.11 mL of 17.5% w/w H₂O₂ was added. To bottle “C” 1.75 mL (2.03 g) of triacetin was added. The amounts of compounds added to each bottle assume 94% conversion of H₂O₂ to peracetic acid such that 2.129% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

The rest of the testing parameters including peracetate concentration, residual hydrogen peroxide measurements were performed as in Example 4.

At 2% w/v peracetate solution an increase in yield in both the conversion of hydrogen peroxide to peracetate and acyl donor to peracetate was seen as compared to the 1.0% w/v peracetate solution.

As seen in the results summarized in Table 11, test performance is significantly improved in the small-batch, laboratory test procedure for preparing nonequilibrium peracetate compositions targeted at 2% peracetate relative to the results in Example 5 targeted to prepare 1% peracetate compositions.

### Example 7: Determination of Near-Stoichiometric Formulation Method Targeting 8% Peracetate Solution

The production of an 8% w/v peracetate solution was targeted to demonstrate a higher practical production concentration that is enabled by the above formulation approach that produces a peracetate solution at pH 12.5 or greater with at least a 90% conversion of hydrogen peroxide to peracetate and less than 1000 mg/L hydrogen peroxide residual.

A number of tests were conducted to examine the properties of a peracetate solution (8.0% w/v target concentration) when produced by controlling the sodium hydroxide to acetyl donor molar ratio (NaOH:acetyl) and the hydrogen peroxide to acetyl donor molar ratio (HP:acetyl). The peracetate solution properties compared in this test matrix include: the percent conversion of hydrogen peroxide to peracetate; the percent conversion of acyl donor to peracetate; concentration of peracetate in solution when first made t=0, and at t=10 and t=30 minutes; the pH of the peracetate solution over time t=0, t=10 and t=30 minutes; and the residual hydrogen peroxide concentration in the peracetate solution when first made. The stability index (SI) was calculated at 10 and 30 minutes. The weight ratio of total organic carbon to peracetate ratio was also calculated. The molar ratio range of NaOH:acetyl donor was 0.80:1 to 1.3:1 and the molar ratio range of HP:acetyl donor was 0.65:1 to 1.10:1. At each of the NaOH:acetyl donor ratios the range of HP:acetyl donor ratios was produced and analyzed. This data is captured in Table 12.

In the formulation tests, the NaOH:acetyl donor molar ratio (moles NaOH/moles acetyl donor) used was 1.10. For these tests the HP:acetyl donor molar ratio was varied over the range of 0.75, 0.80, 0.85, 0.90, 0.95, 1.00, 1.05 and 1.10. This represents a test matrix of 1×8 formulations for preparation and analysis. The ratio of NaOH:H₂O₂ was determined by experimentally following the establishment of the NaOH:acetyl and the HP:acetyl donor molar ratios for all combinations in the test matrix.

The formulations for analysis were made in 100 mL “batches” by the shake bottle method described in Example 4 except where noted. The target concentration of 8.0% w/v peracetate (measured as peracetic acid) was made using 0.112 moles of H₂O₂, which is 6% higher than the expected amount of peracetate (0.105 moles) to compensate for a typical amount of production efficiency loss.

The shake bottle method for making a nominal 8.0% w/v solution concentration as peracetic acid having a 1:1 NaOH:acetyl donor molar ratio, a 1:1 H₂O₂:acetyl donor molar ratio and a 1:1 NaOH:H₂O₂ molar ratio is as follows. Three 125 mL polyethylene bottles were labeled “A”, “B” and “C”. To bottle “A” 58.47 g of deionized water was placed into the polyethylene bottle, 14.10 mL of 25.0% NaOH was added, the composition was mixed by shaking and allowed to stand for at least 1 minute. To bottle “B” 20.45 mL of 17.5% w/w H₂O₂ was added. To bottle “C” 7.00 mL (8.12 g) of triacetin was added. The amounts of compounds added to each bottle assume 94% conversion of H₂O₂ to peracetic acid such that 4.787% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

The rest of the testing parameters including peracetate concentration, residual hydrogen peroxide measurements were performed as in Example 4.

At 8% solution concentration, the concentration of peracetate initially made is expected to decrease at a higher rate than at 4.5% due to either singlet oxygen production (reaction 2 as described in the specification) or other bi-molecular side reactions that naturally increase in rate with increasing concentration. A 10% loss of peracetate concentration at 10 minutes after making an 8% peracetate solution was observed in a similar optimum range as for the 4.5% formulations. However, as the HP:acetyl donor molar ratio decreased to below 0.8:1 the product stability decreased indicating excess acetyl donor is detrimental to high concentrations of peracetate. This result suggests that a 5 minute working time or less is best for concentrations significantly higher than 4.5% peracetate.

TABLE 5

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 25 | 0.80 | 1.10 | 0.73 | 41828 | 2148 | 8.7 | 11.4 | 21795 |
| 26 | 0.80 | 1.05 | 0.76 | 44913 | 2020 | 9.9 | 11.5 | 22851 |
| 27 | 0.80 | 1.00 | 0.80 | 38124 | 1978 | 8.6 | 11.4 | 24590 |
| 28 | 0.80 | 0.95 | 0.84 | 43441 | 1881 | 10.3 | 11.5 | 26405 |
| 29 | 0.80 | 0.90 | 0.89 | 44436 | 1619 | 12.3 | 11.6 | 30245 |
| 30 | 0.80 | 0.85 | 0.94 | 45433 | 800 | 25.4 | 11.5 | 32692 |
| 31 | 0.80 | 0.80 | 1.00 | 45898 | 1076 | 19.1 | 11.9 | 38073 |
| 32 | 0.80 | 0.75 | 1.06 | 46344 | 871 | 23.8 | 11.8 | 35913 |
| 17 | 0.90 | 1.10 | 0.82 | 37693 | 1872 | 9.0 | 12.0 | 28644 |
| 18 | 0.90 | 1.05 | 0.85 | 41501 | 1958 | 9.5 | 11.8 | 27482 |
| 19 | 0.90 | 1.00 | 0.90 | 43321 | 1890 | 10.2 | 11.8 | 28418 |
| 20 | 0.90 | 0.95 | 0.94 | 42835 | 1590 | 12.0 | 11.8 | 31163 |
| 21 | 0.90 | 0.90 | 1.01 | 44124 | 1423 | 13.9 | 11.9 | 35280 |
| 22 | 0.90 | 0.85 | 1.06 | 45684 | 1044 | 19.6 | 11.9 | 35518 |
| 23 | 0.90 | 0.80 | 1.12 | 41251 | 254 | 72.6 | 12.3 | 39343 |
| 24 | 0.90 | 0.75 | 1.20 | 45750 | 0 | | 12.3 | 40893 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 25 | 10.4 | 19559 | 10.0 | 0.52 | 0.47 | 87% | 96% | 0.50 |
| 26 | 10.5 | 19018 | 10.0 | 0.51 | 0.42 | 94% | 99% | 0.49 |
| 27 | 10.4 | 20655 | 10.0 | 0.64 | 0.54 | 80% | 80% | 0.60 |
| 28 | 10.5 | 24623 | 10.1 | 0.61 | 0.57 | 91% | 86% | 0.56 |
| 29 | 10.2 | 28853 | 9.9 | 0.68 | 0.65 | 93% | 84% | 0.57 |
| 30 | 10.4 | 31671 | 10.0 | 0.72 | 0.70 | 95% | 81% | 0.60 |
| 31 | 10.6 | 32786 | 10.2 | 0.83 | 0.71 | 96% | 77% | 0.63 |
| 32 | 10.4 | 34077 | 10.0 | 0.77 | 0.74 | 97% | 73% | 0.66 |
| 17 | 11.9 | 18123 | 11.8 | 0.76 | 0.48 | 79% | 87% | 0.55 |
| 18 | 11.3 | 23382 | 10.5 | 0.66 | 0.56 | 87% | 91% | 0.53 |
| 19 | 11.3 | 26953 | 10.5 | 0.66 | 0.62 | 90% | 90% | 0.53 |
| 20 | 11.2 | 29118 | 10.5 | 0.73 | 0.68 | 89% | 85% | 0.56 |
| 21 | 10.9 | 29447 | 10.4 | 0.80 | 0.67 | 92% | 83% | 0.58 |
| 22 | 10.9 | 32398 | 10.6 | 0.78 | 0.71 | 95% | 81% | 0.59 |
| 23 | 11.1 | 36483 | 10.6 | 0.95 | 0.88 | 86% | 69% | 0.70 |
| 24 | 10.8 | 39189 | 10.6 | 0.89 | 0.86 | 96% | 72% | 0.67 |

TABLE 6

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 9 | 0.95 | 1.10 | 0.87 | 42502 | 1987 | 9.6 | 11.8 | 28102 |
| 10 | 0.95 | 1.05 | 0.90 | 43361 | 2082 | 9.3 | 12.1 | 38202 |
| 11 | 0.95 | 1.00 | 0.96 | 41379 | 1777 | 10.4 | 11.7 | 30375 |
| 12 | 0.95 | 0.95 | 1.00 | 44178 | 1568 | 12.6 | 12.1 | 35128 |
| 13 | 0.95 | 0.90 | 1.06 | 44787 | 1261 | 15.9 | 12.1 | 35437 |
| 14 | 0.95 | 0.85 | 1.12 | 45952 | 597 | 34.4 | 12.0 | 40397 |
| 15 | 0.95 | 0.80 | 1.18 | 46330 | 550 | 37.7 | 12.1 | 42060 |
| 16 | 0.95 | 0.75 | 1.27 | 45563 | 0 | | 12.7 | 40364 |
| 1 | 1.00 | 1.10 | 0.91 | 35916 | 1466 | 11.0 | 12.0 | 26005 |
| 2 | 1.00 | 1.05 | 0.95 | 38861 | 1755 | 9.9 | 12.0 | 26604 |
| 3 | 1.00 | 1.00 | 1.00 | 39971 | 1577 | 11.3 | 12.0 | 29172 |
| 4 | 1.00 | 0.95 | 1.05 | 44969 | 1107 | 18.2 | 12.1 | 39976 |
| 78 | 1.00 | 0.92 | 1.09 | 45672 | 1179 | 17.3 | 12.1 | 39289 |
| 5 | 1.00 | 0.90 | 1.12 | 45563 | | | 12.2 | 39028 |
| 79 | 1.00 | 0.87 | 1.15 | 46112 | 951 | 21.7 | 12.4 | 43162 |
| 6 | 1.00 | 0.85 | 1.18 | 44263 | 849 | 23.3 | 12.3 | 37969 |
| 7 | 1.00 | 0.80 | 1.24 | 46905 | 612 | 34.3 | 12.9 | 43755 |
| 8 | 1.00 | 0.75 | 1.33 | 44839 | 0 | | 12.7 | 43317 |
| 67 | 1.00 | 0.70 | 1.43 | 46627 | 0 | | 12.8 | 45516 |
| 68 | 1.00 | 0.65 | 1.55 | 44839 | 0 | | 12.8 | 43162 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 9 | 11.7 | 22582 | 11.2 | 0.66 | 0.53 | 89% | 98% | 0.49 |
| 10 | 12.2 | 29968 | 12.4 | 0.88 | 0.69 | 91% | 95% | 0.50 |
| 11 | 11.8 | 28102 | 11.2 | 0.73 | 0.68 | 86% | 86% | 0.56 |
| 12 | 11.9 | 28980 | 11.5 | 0.80 | 0.66 | 92% | 88% | 0.55 |
| 13 | 11.7 | 32508 | 11.2 | 0.79 | 0.73 | 94% | 84% | 0.57 |
| 14 | 11.5 | 35754 | 11.0 | 0.88 | 0.78 | 96% | 82% | 0.59 |
| 15 | 11.4 | 36884 | 11.0 | 0.91 | 0.80 | 97% | 77% | 0.62 |
| 16 | 11.8 | 36884 | 11.4 | 0.89 | 0.81 | 95% | 71% | 0.67 |
| 1 | 12.0 | 23703 | 11.5 | 0.72 | 0.66 | 75% | 83% | 0.58 |
| 2 | 11.9 | 25081 | 11.6 | 0.68 | 0.65 | 81% | 85% | 0.56 |
| 3 | 11.7 | 28921 | 10.9 | 0.73 | 0.72 | 83% | 83% | 0.57 |
| 4 | 12.0 | 29154 | 12.0 | 0.89 | 0.65 | 94% | 89% | 0.54 |
| 78 | 12.0 | 37830 | 11.9 | 0.86 | 0.83 | 95% | 88% | 0.55 |
| 5 | 12.0 | 32835 | 12.0 | 0.86 | 0.72 | 95% | 86% | 0.56 |
| 79 | 12.1 | 39722 | 12.1 | 0.94 | 0.86 | 96% | 84% | 0.57 |
| 6 | 11.6 | 37854 | 11.3 | 0.86 | 0.86 | 92% | 79% | 0.61 |
| 7 | 12.7 | 36884 | 12.3 | 0.93 | 0.79 | 98% | 78% | 0.61 |
| 8 | 12.2 | 30485 | 12.0 | 0.97 | 0.68 | 94% | 70% | 0.68 |
| 67 | 12.3 | 36884 | 12.1 | 0.98 | 0.79 | 97% | 68% | 0.70 |
| 68 | 12.4 | 34756 | 12.2 | 0.96 | 0.78 | 94% | 61% | 0.79 |

TABLE 7

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 33 | 1.05 | 1.10 | 0.96 | 45248 | 1866 | 10.8 | 12.0 | 33426 |
| 34 | 1.05 | 1.05 | 1.00 | 46297 | 1611 | 12.8 | 12.2 | 38805 |
| 35 | 1.05 | 1.00 | 1.05 | 46011 | 1573 | 13.1 | 12.2 | 39858 |
| 36 | 1.05 | 0.95 | 1.10 | 44021 | 1118 | 17.6 | 12.4 | 42647 |
| 37 | 1.05 | 0.90 | 1.18 | 46063 | 806 | 25.5 | 12.5 | 47308 |
| 80 | 1.05 | 0.87 | 1.21 | 47726 | 554 | 38.5 | 12.6 | 45337 |
| 38 | 1.05 | 0.85 | 1.24 | 46222 | 507 | 40.8 | 12.2 | 42308 |
| 39 | 1.05 | 0.80 | 1.31 | 48911 | 341 | 64.1 | 12.9 | 42607 |
| 40 | 1.05 | 0.75 | 1.40 | 49651 | 0 | | 13.0 | 46842 |
| 41 | 1.05 | 0.70 | 1.49 | 47523 | 0 | | 13.0 | 45396 |
| 42 | 1.05 | 0.65 | 1.63 | 47949 | 0 | | 12.9 | 46105 |
| 43 | 1.10 | 1.10 | 1.01 | 44729 | 1484 | 13.5 | 12.3 | 41294 |
| 44 | 1.10 | 1.05 | 1.05 | 45846 | 1649 | 12.4 | 12.3 | 45303 |
| 45 | 1.10 | 1.00 | 1.10 | 44846 | 1234 | 16.2 | 12.5 | 42416 |
| 46 | 1.10 | 0.95 | 1.16 | 43775 | 824 | 23.7 | 12.3 | 41336 |
| 47 | 1.10 | 0.90 | 1.23 | 44198 | 552 | 35.8 | 12.5 | 43162 |
| 48 | 1.10 | 0.85 | 1.29 | 49810 | 502 | 44.4 | 12.7 | 46842 |
| 49 | 1.10 | 0.80 | 1.37 | 46788 | 0 | | 13.1 | 45422 |
| 50 | 1.10 | 0.75 | 1.46 | 47129 | 0 | | 13.1 | 46873 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 33 | 12.1 | 26894 | 12.2 | 0.74 | 0.59 | 95% | 104% | 0.46 |
| 34 | 12.0 | 35293 | 12.3 | 0.84 | 0.76 | 97% | 102% | 0.47 |
| 35 | 12.2 | 36082 | 12.2 | 0.87 | 0.78 | 96% | 96% | 0.50 |
| 36 | 12.3 | 32273 | 12.3 | 0.97 | 0.73 | 92% | 87% | 0.55 |
| 37 | 12.4 | 44788 | 12.3 | 1.03 | 0.97 | 96% | 87% | 0.55 |
| 80 | 12.4 | 38524 | 12.2 | 0.95 | 0.81 | 100% | 87% | 0.55 |
| 38 | 11.9 | 35347 | 11.7 | 0.92 | 0.76 | 97% | 82% | 0.58 |
| 39 | 12.7 | 41076 | 12.4 | 0.87 | 0.84 | 102% | 82% | 0.59 |
| 40 | 12.5 | 37226 | 12.3 | 0.94 | 0.75 | 104% | 78% | 0.62 |
| 41 | 12.7 | 40983 | 12.4 | 0.96 | 0.86 | 99% | 69% | 0.69 |
| 42 | 12.6 | 35008 | 12.3 | 0.96 | 0.73 | 100% | 65% | 0.74 |
| 43 | 12.3 | 35207 | 12.4 | 0.92 | 0.79 | 93% | 103% | 0.47 |
| 44 | 12.3 | 34090 | 12.3 | 0.99 | 0.74 | 96% | 101% | 0.48 |
| 45 | 12.4 | 40492 | 12.3 | 0.95 | 0.90 | 94% | 94% | 0.51 |
| 46 | 12.2 | 36884 | 12.2 | 0.94 | 0.84 | 91% | 87% | 0.55 |
| 47 | 12.2 | 39289 | 12.1 | 0.98 | 0.89 | 92% | 83% | 0.58 |
| 48 | 12.6 | 39097 | 12.3 | 0.94 | 0.78 | 104% | 88% | 0.54 |
| 49 | 12.9 | 37285 | 12.6 | 0.97 | 0.80 | 98% | 78% | 0.61 |
| 50 | 12.9 | 34194 | 12.5 | 0.99 | 0.73 | 98% | 74% | 0.65 |

TABLE 8

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 69 | 1.15 | 1.10 | 1.05 | 43932 | 1418 | 13.8 | 12.3 | 42906 |
| 70 | 1.15 | 1.05 | 1.09 | 44613 | 1271 | 15.7 | 12.5 | 43622 |
| 71 | 1.15 | 1.00 | 1.15 | 45089 | 1217 | 16.6 | 12.3 | 44116 |
| 72 | 1.15 | 0.95 | 1.21 | 46472 | 1081 | 19.2 | 12.4 | 42647 |
| 73 | 1.15 | 0.90 | 1.28 | 46834 | 645 | 32.5 | 12.7 | 47046 |
| 74 | 1.15 | 0.87 | 1.32 | 46056 | 606 | 34.0 | 13.3 | 45917 |
| 75 | 1.15 | 0.85 | 1.36 | 46974 | 349 | 60.2 | 13.0 | 45736 |
| 76 | 1.15 | 0.80 | 1.43 | 45924 | 0 | | 12.8 | 43393 |
| 77 | 1.15 | 0.75 | 1.52 | 44596 | 0 | | 13.2 | 42308 |
| 51 | 1.20 | 1.10 | 1.10 | 45578 | 1326 | 15.4 | 12.4 | 43689 |
| 52 | 1.20 | 1.05 | 1.14 | 45715 | 1263 | 16.2 | 12.4 | 35799 |
| 53 | 1.20 | 1.00 | 1.20 | 46465 | 1135 | 18.3 | 12.4 | 41689 |
| 54 | 1.20 | 0.95 | 1.27 | 45261 | 775 | 26.1 | 12.9 | 46814 |
| 55 | 1.20 | 0.90 | 1.34 | 48334 | 496 | 43.6 | 13.2 | 47732 |
| 56 | 1.20 | 0.85 | 1.42 | 47752 | 280 | 76.2 | 12.9 | 43590 |
| 57 | 1.20 | 0.80 | 1.49 | 44925 | 143 | 140.4 | 13.2 | 44998 |
| 58 | 1.20 | 0.75 | 1.60 | 48410 | 0 | | 13.1 | 43746 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 69 | 12.4 | 35314 | 12.4 | 0.98 | 0.80 | 92% | 101% | 0.48 |
| 70 | 12.5 | 36065 | 12.4 | 0.98 | 0.81 | 93% | 98% | 0.49 |
| 71 | 12.2 | 36884 | 12.3 | 0.98 | 0.82 | 94% | 94% | 0.51 |
| 72 | 12.3 | 40983 | 12.2 | 0.92 | 0.88 | 97% | 92% | 0.52 |
| 73 | 12.6 | 43031 | 12.4 | 1.00 | 0.92 | 98% | 88% | 0.55 |
| 74 | 13.2 | 35409 | 12.9 | 1.00 | 0.77 | 96% | 84% | 0.57 |
| 75 | 12.9 | 35518 | 12.7 | 0.97 | 0.76 | 98% | 83% | 0.58 |
| 76 | 12.8 | 38331 | 12.5 | 0.94 | 0.83 | 96% | 77% | 0.63 |
| 77 | 12.9 | 33629 | 12.6 | 0.95 | 0.75 | 93% | 70% | 0.69 |
| 51 | 12.4 | 33578 | 12.4 | 0.96 | 0.74 | 95% | 105% | 0.46 |
| 52 | 12.3 | 33286 | 12.3 | 0.78 | 0.73 | 95% | 100% | 0.48 |
| 53 | 12.4 | 35550 | 12.3 | 0.90 | 0.77 | 97% | 97% | 0.49 |
| 54 | 12.8 | 41694 | 12.6 | 1.03 | 0.92 | 95% | 90% | 0.53 |
| 55 | 12.9 | 41694 | 12.7 | 0.99 | 0.86 | 101% | 91% | 0.53 |
| 56 | 12.9 | 36005 | 12.4 | 0.91 | 0.75 | 100% | 85% | 0.57 |
| 57 | 13.1 | 37580 | 12.7 | 1.00 | 0.84 | 94% | 75% | 0.64 |
| 58 | 12.9 | 37742 | 12.6 | 0.90 | 0.78 | 101% | 76% | 0.63 |

TABLE 9

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 51 | 1.20 | 1.10 | 1.10 | 45578 | 1326 | 15.4 | 12.4 | 43689 |
| 52 | 1.20 | 1.05 | 1.14 | 45715 | 1263 | 16.2 | 12.4 | 35799 |
| 53 | 1.20 | 1.00 | 1.20 | 46465 | 1135 | 18.3 | 12.4 | 41689 |
| 54 | 1.20 | 0.95 | 1.27 | 45261 | 775 | 26.1 | 12.9 | 46814 |
| 55 | 1.20 | 0.90 | 1.34 | 48334 | 496 | 43.6 | 13.2 | 47732 |
| 56 | 1.20 | 0.85 | 1.42 | 47752 | 280 | 76.2 | 12.9 | 43590 |
| 57 | 1.20 | 0.80 | 1.49 | 44925 | 143 | 140.4 | 13.2 | 44998 |
| 58 | 1.20 | 0.75 | 1.60 | 48410 | 0 | | 13.1 | 43746 |
| 59 | 1.30 | 1.10 | 1.19 | 45987 | 1054 | 19.5 | 12.8 | 46058 |
| 60 | 1.30 | 1.05 | 1.24 | 45078 | 1127 | 17.9 | 12.7 | 42635 |
| 61 | 1.30 | 1.00 | 1.31 | 45237 | 699 | 28.9 | 13.2 | 44471 |
| 62 | 1.30 | 0.95 | 1.37 | 45684 | 454 | 45.0 | 13.1 | 44411 |
| 63 | 1.30 | 0.90 | 1.45 | 45911 | 298 | 68.9 | 13.1 | 46058 |
| 64 | 1.30 | 0.85 | 1.54 | 46932 | 129 | 162.6 | 13.1 | 44902 |
| 65 | 1.30 | 0.80 | 1.62 | 47641 | 0 | | 13.3 | 42725 |
| 66 | 1.30 | 0.75 | 1.73 | 47892 | 0 | | 13.4 | 42478 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 51 | 12.4 | 33578 | 12.4 | 0.96 | 0.74 | 95% | 105% | 0.46 |
| 52 | 12.3 | 33286 | 12.3 | 0.78 | 0.73 | 95% | 100% | 0.48 |
| 53 | 12.4 | 35550 | 12.3 | 0.90 | 0.77 | 97% | 97% | 0.49 |
| 54 | 12.8 | 41694 | 12.6 | 1.03 | 0.92 | 95% | 90% | 0.53 |
| 55 | 12.9 | 41694 | 12.7 | 0.99 | 0.86 | 101% | 91% | 0.53 |
| 56 | 12.9 | 36005 | 12.4 | 0.91 | 0.75 | 100% | 85% | 0.57 |
| 57 | 13.1 | 37580 | 12.7 | 1.00 | 0.84 | 94% | 75% | 0.64 |
| 58 | 12.9 | 37742 | 12.6 | 0.90 | 0.78 | 101% | 76% | 0.63 |
| 59 | 12.8 | 43818 | 12.6 | 1.00 | 0.95 | 96% | 106% | 0.45 |
| 60 | 12.6 | 37245 | 12.5 | 0.95 | 0.83 | 94% | 99% | 0.49 |
| 61 | 13.1 | 40573 | 12.7 | 0.98 | 0.90 | 94% | 94% | 0.51 |
| 62 | 13.0 | 36594 | 12.8 | 0.97 | 0.80 | 95% | 91% | 0.53 |
| 63 | 13.1 | 35810 | 12.8 | 1.00 | 0.78 | 96% | 86% | 0.56 |
| 64 | 13.1 | 38093 | 12.7 | 0.96 | 0.81 | 98% | 83% | 0.58 |
| 65 | 13.2 | 34041 | 12.8 | 0.90 | 0.71 | 100% | 80% | 0.60 |
| 66 | 13.0 | 29786 | 12.8 | 0.89 | 0.62 | 100% | 75% | 0.64 |

TABLE 10

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 81 | 1.10 | 1.10 | 0.91 | 6208 | 1805 | 1.5 | 11.9 | 5869 |
| 84 | 1.10 | 0.95 | 1.05 | 7323 | 1583 | 2.1 | 12.1 | 6767 |
| 85 | 1.10 | 0.90 | 1.12 | 6955 | 1461 | 2.1 | 12.1 | 5682 |
| 86 | 1.10 | 0.85 | 1.18 | 7955 | 1333 | 2.7 | 12.1 | 6697 |
| 87 | 1.10 | 0.80 | 1.24 | 7125 | 1293 | 2.5 | 12.0 | 6416 |
| 88 | 1.10 | 0.75 | 1.33 | 8282 | 1040 | 3.6 | 12.3 | 7529 |
| 89 | 1.20 | 0.90 | 1.33 | 7085 | 1401 | 2.3 | 12.3 | 6890 |
| 90 | 1.30 | 0.90 | 1.44 | 7011 | 1345 | 2.3 | 12.4 | 6824 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 81 | 11.6 | 3314 | 11.5 | 0.95 | 0.53 | 58% | 64% | 0.75 |
| 84 | 11.6 | 6554 | 11.5 | 0.92 | 0.90 | 68% | 65% | |
| 85 | 11.9 | 3469 | 11.9 | 0.82 | 0.50 | 65% | 58% | 0.82 |
| 86 | 11.8 | 5387 | 11.8 | 0.84 | 0.68 | 74% | 63% | 0.76 |
| 87 | 11.6 | 4878 | 11.5 | 0.90 | 0.68 | 66% | 53% | 0.90 |
| 88 | 11.8 | 5591 | 11.7 | 0.91 | 0.68 | 77% | 58% | 0.83 |
| 89 | 12.0 | 5413 | 12.0 | 0.97 | 0.76 | 66% | 59% | 0.81 |
| 90 | 12.3 | 5933 | 12.1 | 0.97 | 0.85 | 65% | 59% | 0.82 |

TABLE 11

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 91 | 1.10 | 1.10 | 0.91 | 18944 | 2247 | 3.8 | 12.2 | 13565 |
| 92 | 1.10 | 1.05 | 0.95 | 17780 | 2005 | 4.0 | 12.2 | 15220 |
| 93 | 1.10 | 1.00 | 1.00 | 17726 | 1891 | 4.2 | 12.2 | 15141 |
| 94 | 1.10 | 0.95 | 1.05 | 18270 | 1779 | 4.6 | 12.2 | 17450 |
| 95 | 1.10 | 0.90 | 1.12 | 18851 | 1258 | 6.7 | 12.4 | 18161 |
| 96 | 1.10 | 0.85 | 1.18 | 19133 | 1041 | 8.2 | 12.5 | 18396 |
| 97 | 1.10 | 0.80 | 1.24 | 20175 | 762 | 11.8 | 12.6 | 19370 |
| 100 | 1.10 | 0.75 | 1.33 | 19730 | 573 | 15.4 | 12.6 | 19368 |
| 101 | 1.20 | 0.90 | 1.34 | 18576 | 1128 | 7.4 | 12.6 | 18477 |
| 102 | 1.30 | 0.90 | 1.44 | 19853 | 657 | 13.5 | 12.8 | 18824 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 91 | 11.9 | 9957 | 12.0 | 0.72 | 0.53 | 89% | 98% | 0.49 |
| 92 | 12.0 | 10883 | 12.1 | 0.86 | 0.61 | 84% | 88% | 0.55 |
| 93 | 12.0 | 13052 | 12.1 | 0.85 | 0.74 | 83% | 83% | 0.58 |
| 94 | 12.0 | 13264 | 12.2 | 0.96 | 0.73 | 86% | 82% | 0.59 |
| 95 | 12.1 | 14509 | 12.1 | 0.96 | 0.77 | 89% | 80% | 0.60 |
| 96 | 12.1 | 16951 | 12.1 | 0.96 | 0.89 | 90% | 77% | 0.63 |
| 97 | 12.4 | 18293 | 12.3 | 0.96 | 0.91 | 95% | 76% | 0.63 |
| 100 | 12.6 | 19042 | 12.4 | 0.98 | 0.97 | 93% | 70% | 0.69 |
| 101 | 12.5 | 16763 | 12.3 | 0.99 | 0.90 | 87% | 79% | 0.61 |
| 102 | 12.8 | 17739 | 12.6 | 0.95 | 0.89 | 93% | 84% | 0.57 |

TABLE 12

| | | | | | | G | | |
|---|---|---|---|---|---|---|---|---|
| | B | C | D | E | F | Molar | | I |
| A | Molar | Molar | Molar | PAA | HP | Ratio | H | PAA |
| Ref. | Ratio | Ratio | Ratio | t = 0 | t = 0 | PAA:HP | pH | t = 10 |
| No. | NaOH:AD | HP:AD | NaOH:HP | mg/L | mg/L | t = 0 | t = 0 | mg/L |
| 103 | 1.10 | 1.10 | 0.91 | 64969 | 1547 | 18.8 | 12.0 | 60427 |
| 104 | 1.10 | 1.05 | 0.95 | 74132 | 1436 | 23.1 | 12.0 | 60790 |
| 105 | 1.10 | 1.00 | 1.00 | 75903 | 977 | 34.7 | 12.3 | 67259 |
| 106 | 1.10 | 0.95 | 1.05 | 73195 | 579 | 56.5 | 12.5 | 65417 |
| 107 | 1.10 | 0.90 | 1.12 | 75426 | 472 | 71.4 | 12.7 | 68957 |
| 108 | 1.10 | 0.85 | 1.18 | 76091 | 166 | 204.9 | 12.8 | 64888 |
| 109 | 1.10 | 0.80 | 1.24 | 74642 | 194 | 172.0 | 12.8 | 62420 |
| 110 | 1.10 | 0.75 | 1.33 | 74758 | 185 | 180.6 | 12.8 | 61890 |

| | | | | | | O | P | |
|---|---|---|---|---|---|---|---|---|
| | | K | | | | Yield | Yield | Q |
| A | J | PAA | L | | | PAA | PAA | Wt. |
| Ref. | pH | t = 30 | pH | M | N | from HP | from AD | Ratio |
| No. | t = 10 | mg/L | t = 30 | SI10 | SI30 | % | % | TOC:PAA |
| 103 | 12.1 | 48655 | 12.1 | 0.93 | 0.75 | 76% | 84% | 0.57 |
| 104 | 12.1 | 37607 | 12.1 | 0.82 | 0.51 | 87% | 92% | 0.52 |
| 105 | 12.2 | 46836 | 12.2 | 0.89 | 0.62 | 89% | 89% | 0.54 |
| 106 | 12.2 | 50545 | 12.2 | 0.89 | 0.69 | 86% | 82% | 0.59 |
| 107 | 12.3 | 46273 | 12.2 | 0.91 | 0.61 | 89% | 80% | 0.60 |
| 108 | 12.2 | 38113 | 12.1 | 0.85 | 0.50 | 90% | 76% | 0.63 |
| 109 | 12.2 | 33337 | 12.1 | 0.84 | 0.45 | 88% | 70% | 0.68 |
| 110 | 12.3 | 33230 | 12.2 | 0.83 | 0.44 | 88% | 66% | 0.73 |

### Exemplary Implementation Combinations

Some other contemplated embodiments of implementation combinations for various aspects of this disclosure, with or without additional features as disclosed above or elsewhere herein, are summarized in the numbered paragraphs presented below, and in the appended claims:

### Methods of Preparation

1. A method for preparing a nonequilibrium peracid salt composition in relatively stable form for short-term storage and handling prior to use to generate singlet oxygen during oxidative treatments, the method comprising:
reacting components in an aqueous reaction mixture prepared from a combination of chemical feedstocks to form an aqueous nonequilibrium peracid salt composition, the chemical feedstocks comprising acyl donor, hydrogen peroxide and alkali metal hydroxide in amounts and proportions, including to account for yield losses, to prepare the nonequilibrium peracid salt composition with composition properties comprising:
   dissolved peracid anion of the peracid salt at a concentration in a range of from 1.0% (weight/volume) to 8.0% (weight/volume); and
   pH in a range of from pH 12.0 to pH 13.5; and
wherein the combination of reaction feedstocks comprises:
   a first molar ratio of the alkali metal hydroxide to the acyl donor in a range of from 0.95 to 1.40; and
   a second molar ratio of hydrogen peroxide to the acyl donor in a range of from 0.80 to 1.10; and
continuing the reacting at least until the nonequilibrium peracid salt composition is prepared including the composition properties.

2. The method of paragraph 1, wherein the first molar ratio is at least 1.00.

3. The method of paragraph 1, wherein the first molar ratio is at least 1.02.

4. The method of paragraph 1, wherein the first molar ratio is at least 1.05.

5. The method of paragraph 1, wherein the first molar ratio is at least 1.07.

5.1 The method of paragraph 1, wherein the first molar ratio is at least 1.10.

6. The method of any one of paragraphs 1-5.1, wherein the first molar ratio is no larger than 1.30.

6.1. The method of any one of paragraphs 1-5.1, wherein the first molar ratio is no larger than 1.25.

7. The method of any one of paragraphs 1-5.1, wherein the first molar ratio is no larger than 1.20.

8. The method of any one of paragraphs 1-5.1, wherein the first molar ratio is no larger than 1.15.

9. The method of any one of paragraphs 1-5.1, wherein the first molar ratio is no larger than 1.12.

10. The method of any one of paragraphs 1-9, wherein the pH is at least 12.1.

11. The method of any one of paragraphs 1-9, wherein the pH is at least 12.2.

12. The method of any one of paragraphs 1-9, wherein the pH is at least 12.3.

13. The method of any one of paragraphs 1-9, wherein the pH is at least 12.4.

14. The method of any one of paragraphs 1-9, wherein the pH is at least 12.5.

14.1 The method of any one of paragraphs 1-9, wherein the pH is at least 12.6

14.2 The method of any one of paragraphs 1-9, wherein the pH is at least 12.7.

15. The method of any one of paragraphs 1-14.2, wherein the pH is no larger than 13.3.

16. The method of any one of paragraphs 1-14.2, wherein the pH is no larger than 13.2.

17. The method of any one of paragraphs 1-14.2, wherein the pH is no larger than 13.1.

18. The method of any one of paragraphs 1-14.2, wherein the pH is no larger than 13.0.

19. The method of any one of paragraphs 1-14.2, wherein the pH is no larger than 12.9.

20. The method of any one of paragraphs 1-19, wherein the composition properties comprise a concentration of dissolved hydrogen peroxide of no larger than 1600 mg/L.

21. The method of any one of paragraphs 1-19, wherein the composition properties comprise a concentration of dissolved hydrogen peroxide of no larger than 1400 mg/L.

22. The method of any one of paragraphs 1-19, wherein the composition properties comprise a concentration of dissolved hydrogen peroxide of no larger than 1200 mg/L.

23. The method of any one of paragraphs 1-19, wherein the composition properties comprise a concentration of dissolved hydrogen peroxide of no larger than 1000 mg/L.

24. The method of any one of paragraphs 1-19, wherein the composition properties comprise a concentration of dissolved hydrogen peroxide of no larger than 800 mg/L.

25. The method of any one of paragraphs 1-19, wherein the composition properties comprise a concentration of dissolved hydrogen peroxide of no larger than 600 mg/L.

26. The method of any one of paragraphs 1-25, wherein the composition properties comprise a molar ratio of dissolved hydrogen peroxide to the peracid anion of no larger than 1/6.

27. The method of any one of paragraphs 1-25, wherein the composition properties comprise a molar ratio of dissolved hydrogen peroxide to the peracid anion of no larger than 1/10.

28. The method of any one of paragraphs 1-25, wherein the composition properties comprise a molar ratio dissolved hydrogen peroxide to the peracid anion of no larger than 1/16.

29. The method of any one of paragraphs 1-25, wherein the composition properties comprise a molar ratio of dissolved hydrogen peroxide to the peracid anion of no larger than 1/20.

30. The method of any one of paragraphs 1-25, wherein the composition properties comprise a molar ratio of dissolved hydrogen peroxide to the peracid anion of no larger than 1/25.

31. The method of any one of paragraphs 1-30, wherein the composition properties comprise a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

32. The method of paragraph 31, wherein the 10-minute stability index is at least 0.83.

33. The method of paragraph 31, wherein the 10-minute stability index is at least 0.85.

34. The method of paragraph 31, wherein the 10-minute stability index is at least 0.88.

35. The method of paragraph 31, wherein the 10-minute stability index is at least 0.90.

36. The method of paragraph 31, wherein the 10-minute stability index is at least 0.92.

37. The method of paragraph 31, wherein the 10-minute stability index is at least 0.94.

38. The method of any one of paragraphs 31-37, wherein the 10-minute stability index is no larger than 1.00.

39. The method of any one of paragraphs 31-37, wherein the 10-minute stability index is no larger than 0.99.

40. The method of any one of paragraphs 31-37, wherein the 10-minute stability index is no larger than 0.98.

41. The method of any one of paragraphs 31-37, wherein the 10-minute stability index is no larger than 0.96.

42. The method of any one of paragraphs 1-41, wherein the composition properties comprise a 30-minute stability index (SI₃₀) at a temperature of 22° C. of at least 0.65, wherein the 30-minute stability index is calculated according to Equation II:

$${SI}_{30} = C {A}_{30} / {CA}_{0} \qquad Equation II$$

wherein:
   SI₃₀ is the 30-minute stability index; and
   CA₀ is the concentration (% weight/volume) of the peracid anion determined for a first time
   CA₃₀ is a concentration (% weight/volume) of the peracid anion determined for a third time corresponding to 30 minutes following the first time.

43. The method of paragraph 42, wherein the 30-minute stability index is at least 0.70.

44. The method of paragraph 42, wherein the 30-minute stability index is at least 0.73.

45. The method of paragraph 42, wherein the 30-minute stability index is at least 0.76.

46. The method of paragraph 42, wherein the 30-minute stability index is at least 0.78.

47. The method of paragraph 42, wherein the 30-minute stability index is at least 0.80.

48. The method of paragraph 42, wherein the 30-minute stability index is at least 0.82.

49. The method of any one of paragraphs 42-48, wherein the 30-minute stability index is no larger than 0.95.

50. The method of any one of paragraphs 42-48, wherein the 30-minute stability index is no larger than 0.92.

51. The method of any one of paragraphs 42-48, wherein the 30-minute stability index is no larger than 0.90.

52. The method of any one of paragraphs 42-48, wherein the 30-minute stability index is no larger than 0.88.

53. The method of any one of paragraphs 42-48, wherein the 30-minute stability index is no larger than 0.85.

54. The method of any one of paragraphs 1-53, wherein the composition properties comprise:
the 10-minute stability index recited in any of the preceding numbered paragraphs; and
the 30-minute stability index recited in any of the preceding numbered paragraphs;
and wherein the 30-minute stability index is smaller than the 10-minute stability index.

55. The method of paragraph 54, wherein the 30-minute stability index is smaller than the 10-minute stability index by at least 0.05.

56. The method of paragraph 54, wherein the 30-minute stability index is smaller than the 10-minute stability index by at least 0.10.

57. The method of any one of paragraphs 54-56, wherein the 30-minute stability index is smaller than the 10-minute stability index by an amount no larger than 0.20.

58. The method of any one of paragraphs 54-56, wherein the 30-minute stability index is smaller than the 10-minute stability index by an amount no larger than 0.15.

59. The method of any one of paragraphs 1-58, wherein the second molar ratio is at least 0.83.

60. The method of any one of paragraphs 1-58, wherein the second molar ratio is at least 0.85.

61. The method of any one of paragraphs 1-58, wherein the second molar ratio is at least 0.87.

62. The method of any one of paragraphs 1-58, wherein the second molar ratio is at least 0.90.

63. The method of any one of paragraphs 1-58, wherein the second molar ratio is at least 0.92.

64. The method of any one of paragraphs 1-58, wherein the second molar ratio is at least 0.95.

65. The method of any one of paragraphs 1-64, wherein the second molar ratio is no larger than 1.05.

66. The method of any one of paragraphs 1-64, wherein the second molar ratio is no larger than 1.02.

67. The method of any one of paragraphs 1-64, wherein the second molar ratio is no larger than 1.00.

68. The method of any one of paragraphs 1-64, wherein the second molar ratio is no larger than 0.99.

69. The method of any one of paragraphs 1-64, wherein the second molar ratio is no larger than 0.97.

70. The method of any one of paragraphs 1-64, wherein the second molar ratio is no larger than 0.95.

71. The method of any one of paragraphs 1-63, wherein the second molar ratio is no larger than 0.92.

72. The method of any one of paragraphs 1-62, wherein the second molar ratio is no larger than 0.90.

73. The method of any one of paragraphs 1-72, wherein the composition properties comprise a weight ratio of total organic carbon to the peracid anion of no larger than 0.60.

74. The method of any one of paragraphs 1-72, wherein the composition properties comprise a weight ratio of total organic carbon to the peracid anion of no larger than 0.59.

75. The method of any one of paragraphs 1-72, wherein the composition properties comprise a weight ratio of total organic carbon to the peracid anion of no larger than 0.58.

76. The method of any one of paragraphs 1-72, wherein the composition properties comprise a weight ratio of total organic carbon to the peracid anion of no larger than 0.57.

77. The method of any one of paragraphs 1-72, wherein the composition properties comprise a weight ratio of total organic carbon to the peracid anion of no larger than 0.55.

78. The method of any one of paragraphs 1-72, wherein the composition properties comprise a weight ratio of total organic carbon to the peracid anion of no larger than 0.53

79. The method of any one of paragraphs 1-78, wherein the composition properties comprise a weight ratio of total organic carbon to the peracid anion of at least 0.48.

80. The method of any one of paragraphs 1-78, wherein the composition properties comprise a weight ratio of total organic carbon to the peracid anion of at least 0.50.

81. The method of any one of paragraphs 1-78, wherein the composition properties comprise a weight ratio of total organic carbon to the peracid anion of at least 0.52.

82. The method of any one of paragraphs 1-77 wherein the composition properties comprise a weight ratio of total organic carbon to the peracid anion of at least 0.54.

83. The method of any one of paragraphs 1-82, wherein the composition properties comprise a molar ratio of the peracid anion to the peracid of at least 10,000.

84. The method of any one of paragraphs 1-82, wherein the composition properties comprise a molar ratio of the peracid anion to the peracid of at least 15,000.

85. The method of any one of paragraphs 1-82, wherein the composition properties comprise a molar ratio of the peracid anion to the peracid of at least 18,000.

86. The method of any one of paragraphs 1-85, wherein the composition properties comprise a molar ratio of the peracid anion to the peracid of no larger than 40,000.

87. The method of any one of paragraphs 1-85, wherein the composition properties comprise a molar ratio of the peracid anion to the peracid of no larger than 38,000.

88. The method of any one of paragraphs 1-87, wherein the chemical feedstocks for the aqueous reaction mixture are in amounts and proportions to prepare the nonequilibrium peracid salt composition with the composition properties at a first yield of the peracid anion relative to the acyl donor of at least 75%.

89. The method of paragraph 88, wherein the first yield is at least 78%.

90. The method of paragraph 88, wherein the first yield is at least 80%.

91. The method of paragraph 88, wherein the first yield is at least 83%.

92. The method of paragraph 88, wherein the first yield is at least 85%.

93. The method of paragraph 88, wherein the first yield is at least 87%.

94. The method of paragraph 88, wherein the first yield is at least 89%.

95. The method of any one of paragraphs 88-94, wherein the first yield is no larger than 97%.

96. The method of any one of paragraphs 88-94, wherein the first yield is no larger than 95%.

97. The method of any one of paragraphs 88-94, wherein the first yield is no larger than 93%.

98. The method of any one of paragraphs 88-94, wherein the first yield is no larger than 90%.

99. The method of any one of paragraphs 1-98, wherein the chemical feedstocks for the aqueous reaction mixture or in amounts and proportions to prepare the nonequilibrium peracid salt composition with the composition properties at a second yield of the peracid anion relative to the hydrogen peroxide of at least 85%.

100. The method of paragraph 99, wherein the second yield is at least 88%.

101. The method of paragraph 99, wherein the second yield is the least 90%.

102. The method of paragraph 99, wherein the second yield is at least 92%.

103. The method of paragraph 99, wherein the second yield is at least 94%.

104. The method of paragraph 99, wherein the second yield is at least 96%.

105. The method of paragraph 99, wherein the second yield is at least 97%.

106. The method of any one of paragraphs 1-105, comprising the first yield of any one of paragraphs 88-98 and the second yield of any one of paragraphs 89-105, and wherein the first yield and the second yield are equal or differ by no more than 15 percentage points.

107. The method of any one of paragraphs 99-105, wherein the first yield and the second yield are equal or differ by no more than 12 percentage points.

108. The method of any one of paragraphs 99-105, wherein the first yield and the second yield are equal or differ by no more than 10 percentage points.

109. The method of any one of paragraphs 99-105, wherein the first yield and the second yield are equal or differ by no more than eight percentage points.

110. The method of any one of paragraphs 99-105, wherein the first yield and the second yield are equal or differ by no more than six percentage points.

111. The method of any one of paragraphs 99-110, wherein the first yield is larger than the second yield.

112. The method of any one of paragraphs 99-110, wherein the second yield is larger than the first yield.

113. The method of any one of paragraphs 1-112, wherein the nonequilibrium peracid salt composition is a nonequilibrium peracetic acid salt composition and the peracid anion is peracetate.

114. The method of any one of paragraphs 1-113, wherein the composition properties comprise the peracid anion at a concentration of at least 1.5% (weight/volume).

115. The method of any one of paragraphs 1-113, wherein the composition properties comprise the peracid anion at a concentration of at least 2.0% (weight/volume).

116. The method of any one of paragraphs 1-113, wherein the composition properties comprise the peracid anion at a concentration of at least 2.5% (weight/volume).

117. The method of any one of paragraphs 1-113, wherein the composition properties comprise the peracid anion at a concentration of at least 3.0% (weight/volume).

118. The method of any one of paragraphs 1-113, wherein the composition properties comprise the peracid anion at a concentration of at least 3.5% (weight/volume).

119. The method of any one of paragraphs 1-113, wherein the composition properties comprise the peracid anion at a concentration of at least 4.0% (weight/volume).

120. The method of any one of paragraphs 1-113, wherein the composition properties comprise the peracid anion at a concentration of at least 4.5% (weight/volume).

121. The method of any one of paragraphs 1-113, wherein the composition properties comprise the peracid anion at a concentration of at least 5.0% (weight/volume).

122. The method of any one of paragraphs 1-113, wherein the composition properties comprise the peracid anion at a concentration of at least 5.5% (weight/volume).

123. The method of any one of paragraphs 1-113, wherein the composition properties comprise the peracid anion at a concentration of at least 6.0% (weight/volume).

124. The method of any one of paragraphs 1-113, wherein the composition properties comprise the peracid anion at a concentration of at least 6.5% (weight/volume).

125. The method of any one of paragraphs 1-113, wherein the composition properties comprise the peracid anion at a concentration of at least 7.0% (weight/volume).

126. The method of any one of paragraphs 1-125, wherein the composition properties comprise the peracid anion at a concentration of no larger than 8.0% (weight/volume).

127. The method of any one of paragraphs 1-125, wherein the composition properties comprise the peracid anion at a concentration of no larger than 7.5% (weight/volume).

128. The method of any one of paragraphs 1-125, wherein the composition properties comprise the peracid anion at a concentration of no larger than 7.0% (weight/volume).

129. The method of any one of paragraphs 1-124, wherein the composition properties comprise the peracid anion at a concentration of no larger than 6.5% (weight/volume).

130. The method of any one of paragraphs 1-123, wherein the composition properties comprise the peracid anion at a concentration of no larger than 6.0% (weight/volume).

131. The method of any one of paragraphs 1-122, wherein the composition properties comprise the peracid anion at a concentration of no larger than 5.5% (weight/volume).

132. The method of any one of paragraphs 1-121, wherein the composition properties comprise the peracid anion at a concentration of no larger than 5.0% (weight/volume).

133. The method of any one of paragraphs 1-120, wherein the composition properties comprise the peracid anion at a concentration of no larger than 4.5% (weight/volume).

134. The method of any one of paragraphs 1-119, wherein the composition properties comprise the peracid anion at a concentration of no larger than 4.0% (weight/volume).

135. The method of any one of paragraphs 1-118, wherein the composition properties comprise the peracid anion at a concentration of no larger than 3.5% (weight/volume).

136. The method of any one of paragraphs 1-117, wherein the composition properties comprise the peracid anion at a concentration of no larger than 3.0% (weight/volume).

137. The method of any one of paragraphs 1-116, wherein the composition properties comprise the peracid anion at a concentration of no larger than 2.5% (weight/volume).

138. The method of any one of paragraphs 1-115, wherein the composition properties comprise the peracid anion at a concentration of no larger than 2.0% (weight/volume).

139. The method of any one of paragraphs 1-113, 117-124 and 130-136, wherein:
the first molar ratio is in a range of from 1.00 to 1.30;
the second molar ratio is in a range of from 0.83 to 1.00;
the composition properties comprise;
   the peracid anion at a concentration in a range of from 3.0% (weight/volume) to 6.5% (weight/volume);
   a 10-minute stability index (SI₁₀) of at least 0.85 calculated according to Equation I;
   a concentration of hydrogen peroxide of no larger than 1200 mg/L; and a pH of at least 12.1; and
the chemical feedstocks for the aqueous reaction mixture are in amounts and proportions to prepare the nonequilibrium peracid salt composition with the composition properties at a first yield of the peracid anion relative to the acyl donor of at least 80% and a second yield of the peracid anion relative to hydrogen peroxide of at least 90%.

140. The method of paragraph 139, wherein:
the first molar ratio being at least 1.02;
the second molar ratio being at least 0.85; and
the composition properties comprise a pH of at least 12.3.

141. The method of either one of paragraph 139 or paragraph 140, wherein the composition properties comprise a weight ratio of total organic carbon to the peracid anion of no larger than 0.58.

142. The method of any one of paragraphs 139-141, wherein:
the first molar ratio is at least 1.05;
the second molar ratio is at least 0.87; and
the composition properties comprise a pH of at least 12.4.

143. The method of any one of paragraphs 139-142, wherein the first molar ratio is no larger than 1.20.

144. The method of any one of paragraphs 139-143, wherein the second molar ratio is no larger than 0.97.

145. The method of any one of paragraphs 1-117 and 136-138, wherein:
the first molar ratio is in a range of from 1.05 to 1.30;
the second molar ratio is in a range of from 0.80 to 0.95;
the composition properties comprise;
   the peracid anion at a concentration in a range of from 1.5% (weight/volume) to 3.0% (weight/volume);
   a 10-minute stability index (SI₁₀) of at least 0.90 calculated according to Equation I;
   a concentration of hydrogen peroxide of no larger than 1200 mg/L; and
   a pH of at least 12.3; and
the chemical feedstocks for the aqueous reaction mixture are in amounts and proportions to prepare the nonequilibrium peracid salt composition with the composition properties at a first yield of the peracid anion relative to the acyl donor of at least 75% and a second yield of the peracid anion relative to hydrogen peroxide of at least 88%.

146. The method of any one of paragraphs 1-130, wherein:
the first molar ratio is in a range of from 1.00 to 1.30;
the second molar ratio is in a range of from 0.85 to 1.00;
the composition properties comprise;
   the peracid anion at a concentration in a range of from 6.0% (weight/volume) to 8.0% (weight/volume);
   a 10-minute stability index (SI₁₀) of at least 0.88 calculated according to Equation I;
   a concentration of hydrogen peroxide of no larger than 1200 mg/L; and
   a pH of at least 12.2; and
the chemical feedstocks for the aqueous reaction mixture are in amounts and proportions to prepare the nonequilibrium peracid salt composition with the composition properties at a first yield of the peracid anion relative to the acyl donor of at least 80% and a second yield of the peracid anion relative to hydrogen peroxide of at least 86%.

147. The method of any one of paragraphs 1-146, comprising mixing the reaction mixture during the reacting.

148. The method of any one of paragraphs 1-147, comprising preparing the reaction mixture, the preparing the reaction mixture comprising combining a first feedstock preparation comprising an alkaline hydrogen peroxide solution with a second feedstock preparation comprising the acyl donor;
optionally, the method comprises preparing the first feedstock preparation; and
optionally, the method comprises preparing the second feedstock preparation.

149. The method of any one of paragraphs 1-148, wherein the combination of reaction feedstocks comprises a third molar ratio of the alkali metal hydroxide to hydrogen peroxide in a range of from 1.00 to 1.63, and optionally the alkaline hydrogen peroxide solution of the first feedstock preparation of paragraph 148 is a preparation with the alkali metal hydroxide and hydrogen peroxide in the third molar ratio.

150. The method of paragraph 149, wherein the third molar ratio is at least 1.05.

151. The method of paragraph 149, wherein the third molar ratio is at least 1.10.

152. The method of paragraph 149, wherein the third molar ratio is at least 1.15.

153. The method of paragraph 149, wherein the third molar ratio is at least 1.20.

154. The method of paragraph 149, wherein the third molar ratio is at least 1.25.

155. The method of paragraph 149, wherein the third molar ratio is at least 1.30.

156. The method of paragraph 149, wherein the third molar ratio is at least 1.35.

157. The method of paragraph 149, wherein the third molar ratio is at least 1.40.

158. The method of paragraph 149, wherein the third molar ratio is at least 1.45.

159. The method of paragraph 149, wherein the third molar ratio is at least 1.50.

160. The method of paragraph 149, wherein the third molar ratio is at least 1.55.

161. The method of any one of paragraphs 149-160, wherein the third molar ratio is no larger than 1.60.

162. The method of any one of paragraphs 149-160, wherein the third molar ratio is no larger than 1.55.

163. The method of any one of paragraphs 149-159, wherein the third molar ratio is no larger than 1.50.

164. The method of any one of paragraphs 149-158, wherein the third molar ratio is no larger than 1.45.

165. The method of any one of paragraphs 149-157, wherein the third molar ratio is no larger than 1.40.

166. The method of any one of paragraphs 149-156, wherein the third molar ratio is no larger than 1.35.

167. The method of any one of paragraphs 149-155, wherein the third molar ratio is no larger than 1.30.

168. The method of any one of paragraphs 149-154, wherein the third molar ratio is no larger than 1.25.

169. The method of any one of paragraphs 149-153, wherein the third molar ratio is no larger than 1.20.

170. The method of any one of paragraphs 1-169, wherein the acyl donor is in acetyl donor.

171. The method of paragraph 170, wherein the acetyl donor comprises triacetin.

172. The method of either one of paragraph 170 or paragraph 171, wherein the acetyl donor comprises acetylsalicylic acid.

173. The method of any one of paragraphs 170-172, wherein the acetyl donor comprises tetraacetylethylenediamine.

173.1 The method of any one of paragraphs 1-173, wherein the prepared nonequilibrium peracid salt solution is the nonequilibrium peracid salt composition of any one of paragraphs 203-296.

### Method of Treatment

174. A method of oxidative treatment of a substrate, comprising:
preparing a nonequilibrium peracid salt composition according to the method of any one of paragraphs 1-173.1; and
contacting the substrate with the nonequilibrium peracid salt composition.

175. A method of oxidative treatment of a substrate, comprising:
contacting the substrate with a nonequilibrium peracid salt composition prepared according to the method of any one of paragraphs 1-173.1.

175.1. A method of oxidative treatment of a substrate, comprising:
contacting the substrate with the nonequilibrium peracid salt composition of any one of paragraphs 203-297.

176. Use of nonequilibrium peracid salt composition prepared according to the method of any one of paragraphs 1-173.1 to oxidatively treat a substrate.

177. The method or use of any one of paragraphs 174-176, wherein the contacting is at a pH that is lower than a pH of the nonequilibrium peracid salt composition immediately prior to the contacting.

178. The method or use of paragraph 177, wherein the contacting is at a pH at least one-half pH unit smaller than the pH of the nonequilibrium peracid salt composition immediately prior to the contacting.

179. The method or use of paragraph 177, wherein the contacting is at a pH at least one pH unit smaller than the pH of the nonequilibrium peracid salt composition immediately prior to the contacting.

180. The method or use of paragraph 177, wherein the contacting is at a pH at least two pH units smaller than the pH of the nonequilibrium peracid salt composition immediately prior to the contacting.

181. The method or use of paragraph 177, wherein the contacting is at a pH at least three pH units smaller than the pH of the nonequilibrium peracid salt composition immediately prior to the contacting.

182. The method or use of paragraph 177, wherein the contacting is at a pH at least four pH units smaller than the pH of the nonequilibrium peracid salt composition immediately prior to the contacting.

183. The method or use of any one of paragraphs 174-182, wherein the substrate comprises an aqueous liquid at a pH at least one pH unit smaller than the pH of the nonequilibrium peracid salt composition immediately prior to the contacting.

184. The method or use of any one of paragraphs 174-182, wherein the substrate comprises an aqueous liquid at a pH at least two pH units smaller than the pH of the nonequilibrium peracid salt composition immediately prior to the contacting.

185. The method or use of any one of paragraphs 174-182, wherein the substrate comprises an aqueous liquid at a pH at least three pH units smaller than the pH of the nonequilibrium peracid salt composition immediately prior to the contacting.

186. The method or use of any one of paragraphs 174-182, wherein the substrate comprises an aqueous liquid at a pH at least four pH units smaller than the pH of the nonequilibrium peracid salt composition immediately prior to the contacting.

187. The method of any one of paragraphs 174-186, wherein the substrate comprises a slurry comprising the aqueous liquid and pulp to be oxidatively treated, optionally to delignify and/or bleach the pulp.

188. A method of oxidative treatment of a substrate, comprising:
preparing a nonequilibrium peracid salt composition according to the method of any one of paragraphs 1-173.1;
diluting the nonequilibrium peracid salt composition to prepare a diluted nonequilibrium peracid salt composition; and
contacting the substrate with the diluted nonequilibrium peracid salt composition.

189. A method of oxidative treatment of a substrate, comprising:
diluting a nonequilibrium peracid salt composition prepared according to any one of paragraphs 1-173.1 to prepare a diluted nonequilibrium peracid salt composition; and
contacting the substrate with a diluted nonequilibrium peracid salt composition.

190. A method of oxidative treatment of a substrate, comprising:
diluting a nonequilibrium peracid salt composition of any one of paragraphs 203-297 to prepare a diluted nonequilibrium peracid salt composition; and
contacting the substrate with a diluted nonequilibrium peracid salt composition.

191. The method of any one of paragraphs 188-190, comprising contacting the substrate with the diluted nonequilibrium peracid salt composition within 120 minutes after preparation of the nonequilibrium peracid salt composition.

192. The method or use of any one of paragraphs 174-191, wherein the substrate comprises a surface of a solid object, and optionally to sanitize the surface.

193. The method or use of any one of paragraphs 174-191, wherein the substrate comprises a water to be treated.

194. The method or use of any one of paragraphs 174-191, comprising adding an acidulant to reduce the pH of the nonequilibrium peracid salt composition prior to the contacting.

195. The method or use of any one of paragraphs 174-194, comprising generating singlet oxygen in the presence of the substrate as a consequence of contacting the substrate with the nonequilibrium peracid salt composition or the diluted nonequilibrium peracid salt composition.

### Compositions

203. An aqueous, nonequilibrium peracid salt composition for generation of singlet oxygen for use in oxidative treatments, the composition comprising:
dissolved peracid anion of an alkali metal salt of a peracid at a concentration in a range of from 1.0% (weight/volume) to 8.0% (weight/volume);
pH in a range of from pH 12.0 to pH 13.5;
a concentration of dissolved hydrogen peroxide of no more than 1400 mg/L;
a 10-minute stability index (SI₁₀) at a temperature of 22° C. of at least 0.80, wherein the 10-minute stability index is calculated according to Equation I:

$$S {I}_{10} = C {A}_{10} / {CA}_{0} \qquad Equation I$$

wherein:
   SI₁₀ is the 10-minute stability index;
   CA₀ is the concentration (% weight/volume) of the peracid anion determined for a first time; and
   CA₁₀ is a concentration (% weight/volume) of the peracid anion
determined for a second time corresponding to 10 minutes following the first time.

204. The composition of paragraph 203, wherein the pH is at least 12.1.

205. The composition of paragraph 203, wherein the pH is at least 12.2.

206. The composition of paragraph 203, wherein the pH is at least 12.3.

207. The composition of paragraph 203, wherein the pH is at least 12.4.

208. The composition of paragraph 203, wherein the pH is at least 12.5.

208.1 The composition of paragraph 203, wherein the pH is at least 12.6.

208.2 The composition of paragraph 203, wherein the pH is at least 12.7.

209. The composition of any one of paragraphs 203-208.2, wherein the pH is no larger than 13.3.

210. The composition of any one of paragraphs 203-208.2, wherein the pH is no larger than 13.2.

211. The composition of any one of paragraphs 203-208.2, wherein the pH is no larger than 13.1.

212. The composition of any one of paragraphs 203-208.2, wherein the pH is no larger than 13.0.

213. The composition of any one of paragraphs 203-208.2, wherein the pH is no larger than 12.9.

214. The composition of any one of paragraphs 203-213, comprising a concentration of dissolved hydrogen peroxide of no larger than 1200 mg/L.

215. The composition of any one of paragraphs 203-213, comprising a concentration of dissolved hydrogen peroxide of no larger than 1000 mg/L.

216. The composition of any one of paragraphs 203-213, comprising a concentration of dissolved hydrogen peroxide of no larger than 800 mg/L.

217. The composition of any one of paragraphs 203-213, comprising a concentration of dissolved hydrogen peroxide of no larger than 600 mg/L.

218. The composition of any one of paragraphs 203-217, comprising a molar ratio of dissolved hydrogen peroxide to the peracid anion of no larger than 1/6.

219. The composition of any one of paragraphs 203-217, comprising a molar ratio of dissolved hydrogen peroxide to the peracid anion of no larger than 1/10.

220. The composition of any one of paragraphs 203-217, comprising a molar ratio dissolved hydrogen peroxide to the peracid anion of no larger than 1/16.

221. The composition of any one of paragraphs 203-217, comprising a molar ratio of dissolved hydrogen peroxide to the peracid anion of no larger than 1/20.

222. The composition of any one of paragraphs 203-217, comprising a molar ratio of dissolved hydrogen peroxide to the peracid anion of no larger than 1/25.

223. The composition of any one of paragraphs 203-222, wherein the 10-minute stability index is at least 0.83.

224. The composition of any one of paragraphs 203-222, wherein the 10-minute stability index is at least 0.85.

225. The composition of any one of paragraphs 203-222, wherein the 10-minute stability index is at least 0.88.

226. The composition of any one of paragraphs 203-222, wherein the 10-minute stability index is at least 0.90.

227. The composition of any one of paragraphs 203-222, wherein the 10-minute stability index is at least 0.92.

228. The composition of any one of paragraphs 203-222, wherein the 10-minute stability index is at least 0.94.

229. The composition of any one of paragraphs 203-228, wherein the 10-minute stability index is no larger than 1.00.

230. The composition of any one of paragraphs 203-228, wherein the 10-minute stability index is no larger than 0.99.

231. The composition of any one of paragraphs 203-228, wherein the 10-minute stability index is no larger than 0.98.

232. The composition of any one of paragraphs 203-228, wherein the 10-minute stability index is no larger than 0.96.

233. The composition of any one of paragraphs 203-232, comprising a 30-minute stability index (SI₃₀) at a temperature of 22° C. of at least 0.65, wherein the 30-minute stability index is calculated according to Equation II:

$${SI}_{30} = C {A}_{30} / {CA}_{0} \qquad Equation II$$

wherein:
   SI₃₀ is the 30-minute stability index; and
   CA₀ is the concentration (% weight/volume) of the peracid anion determined for a first time
   CA₃₀ is a concentration (% weight/volume) of the peracid anion determined for a third time corresponding to 30 minutes following the first time.

234. The composition of paragraph 233, wherein the 30-minute stability index is at least 0.70.

235. The composition of paragraph 233, wherein the 30-minute stability index is at least 0.73.

236. The composition of paragraph 233, wherein the 30-minute stability index is at least 0.76.

237. The composition of paragraph 233, wherein the 30-minute stability index is at least 0.78.

238. The composition of paragraph 233, wherein the 30-minute stability index is at least 0.80.

239. The composition of paragraph 233, wherein the 30-minute stability index is at least 0.82.

240. The composition of any one of paragraphs 233-239, wherein the 30-minute stability index is no larger than 0.95.

241. The composition of any one of paragraphs 233-239, wherein the 30-minute stability index is no larger than 0.92.

242. The composition of any one of paragraphs 233-239, wherein the 30-minute stability index is no larger than 0.90.

243. The composition of any one of paragraphs 233-239, wherein the 30-minute stability index is no larger than 0.88.

244. The composition of any one of paragraphs 233-239, wherein the 30-minute stability index is no larger than 0.85.

245. The composition of any one of paragraphs 233-244, wherein the 30-minute stability index is smaller than the 10-minute stability index.

246. The composition of paragraph 245, wherein the 30-minute stability index is smaller than the 10-minute stability index by at least 0.05.

247. The composition of paragraph 245, wherein the 30-minute stability index is smaller than the 10-minute stability index by at least 0.10.

248. The composition of any one of paragraphs 245-247, wherein the 30-minute stability index is smaller than the 10-minute stability index by an amount no larger than 0.20.

249. The composition of any one of paragraphs 245-247, wherein the 30-minute stability index is smaller than the 10-minute stability index by an amount no larger than 0.15.

250. The composition of any one of paragraphs 203-249, comprising a weight ratio of total organic carbon to the peracid anion of no larger than 0.60.

251. The composition of any one of paragraphs 203-249, comprising a weight ratio of total organic carbon to the peracid anion of no larger than 0.59.

252. The composition of any one of paragraphs 203-249, comprising a weight ratio of total organic carbon to the peracid anion of no larger than 0.58.

253. The composition of any one of paragraphs 203-249, comprising a weight ratio of total organic carbon to the peracid anion of no larger than 0.57.

254. The composition of any one of paragraphs 203-249, comprising a weight ratio of total organic carbon to the peracid anion of no larger than 0.55.

255. The composition of any one of paragraphs 203-249, comprising a weight ratio of total organic carbon to the peracid anion of no larger than 0.53

256. The composition of any one of paragraphs 203-255, comprising a weight ratio of total organic carbon to the peracid anion of at least 0.48.

257. The composition of any one of paragraphs 203-255, comprising a weight ratio of total organic carbon to the peracid anion of at least 0.50.

258. The composition of any one of paragraphs 203-255, comprising a weight ratio of total organic carbon to the peracid anion of at least 0.52.

259. The composition of any one of paragraphs 203-254, comprising a weight ratio of total organic carbon to the peracid anion of at least 0.54.

260. The composition of any one of paragraphs 203-259, comprising a molar ratio of the peracid anion to the peracid of at least 10,000.

261. The composition of any one of paragraphs 203-259, comprising a molar ratio of the peracid anion to the peracid of at least 15,000.

262. The composition of any one of paragraphs 203-259, comprising a molar ratio of the peracid anion to the peracid of at least 18,000.

263. The composition of any one of paragraphs 203-262, comprising a molar ratio of the peracid anion to the peracid of no larger than 40,000.

264. The composition of any one of paragraphs 203-262, comprising a molar ratio of the peracid anion to the peracid of no larger than 38,000.

265. The composition of any one of paragraphs 203-264, wherein the nonequilibrium peracid salt composition is a nonequilibrium peracetic acid salt composition and the peracid anion is peracetate.

266. The composition of any one of paragraphs 203-265, comprising the peracid anion at a concentration of at least 1.5% (weight/volume).

267. The composition of any one of paragraphs 203-265, comprising the peracid anion at a concentration of at least 2.0% (weight/volume).

268. The composition of any one of paragraphs 203-265, comprising the peracid anion at a concentration of at least 2.5% (weight/volume).

269. The composition of any one of paragraphs 203-265, comprising the peracid anion at a concentration of at least 3.0% (weight/volume).

270. The composition of any one of paragraphs 203-265, comprising the peracid anion at a concentration of at least 3.5% (weight/volume).

271. The composition of any one of paragraphs 203-265, comprising the peracid anion at a concentration of at least 4.0% (weight/volume).

272. The composition of any one of paragraphs 203-265, comprising the peracid anion at a concentration of at least 4.5% (weight/volume).

273. The composition of any one of paragraphs 203-265, comprising the peracid anion at a concentration of at least 5.0% (weight/volume).

274. The composition of any one of paragraphs 203-265, comprising the peracid anion at a concentration of at least 5.5% (weight/volume).

275. The composition of any one of paragraphs 203-265, comprising the peracid anion at a concentration of at least 6.0% (weight/volume).

276. The composition of any one of paragraphs 203-265, comprising the peracid anion at a concentration of at least 6.5% (weight/volume).

277. The composition of any one of paragraphs 203-265, comprising the peracid anion at a concentration of at least 7.0% (weight/volume).

278. The composition of any one of paragraphs 203-277, comprising the peracid anion at a concentration of no larger than 8.0% (weight/volume).

279. The composition of any one of paragraphs 203-277, comprising the peracid anion at a concentration of no larger than 7.5% (weight/volume).

280. The composition of any one of paragraphs 203-277, comprising the peracid anion at a concentration of no larger than 7.0% (weight/volume).

281. The composition of any one of paragraphs 203-276, comprising the peracid anion at a concentration of no larger than 6.5% (weight/volume).

282. The composition of any one of paragraphs 203-275, comprising the peracid anion at a concentration of no larger than 6.0% (weight/volume).

283. The composition of any one of paragraphs 203-274, comprising the peracid anion at a concentration of no larger than 5.5% (weight/volume).

284. The composition of any one of paragraphs 203-273, comprising the peracid anion at a concentration of no larger than 5.0% (weight/volume).

285. The composition of any one of paragraphs 203-272, comprising the peracid anion at a concentration of no larger than 4.5% (weight/volume).

286. The composition of any one of paragraphs 203-271, comprising the peracid anion at a concentration of no larger than 4.0% (weight/volume).

287. The composition of any one of paragraphs 203-270, comprising the peracid anion at a concentration of no larger than 3.5% (weight/volume).

288. The composition of any one of paragraphs 203-269, comprising the peracid anion at a concentration of no larger than 3.0% (weight/volume).

289. The composition of any one of paragraphs 203-268, comprising the peracid anion at a concentration of no larger than 2.5% (weight/volume).

290. The composition of any one of paragraphs 203-267, comprising the peracid anion at a concentration of no larger than 2.0% (weight/volume).

291. The composition of any one of paragraphs 203-265, 269-274 and 282-288, comprising:
the peracid anion at a concentration in a range of from 3.0% (weight/volume) to 6.0% (weight/volume);
the 10-minute stability index (SI₁₀) being at least 0.85;
the concentration of dissolved hydrogen peroxide being no larger than 1200 mg/L; and
the pH being at least 12.1.

292. The composition of paragraph 291, comprising a pH of at least 12.3.

293. The composition of either one of paragraph 291 or paragraph 292, comprising a weight ratio of total organic carbon to the peracid anion of no larger than 0.58.

294. The composition of any one of paragraphs 291-293, wherein the pH is at least 12.4.

295. The composition of any one of paragraphs 203-269 and 288-290, comprising:
the peracid anion at a concentration in a range of from 1.5% (weight/volume) to 3.0% (weight/volume);
the 10-minute stability index (SI₁₀) being at least 0.90;
the concentration of dissolved hydrogen peroxide being no larger than 1200 mg/L; and
the pH being at least 12.3.

296. The composition of any one of paragraphs 203-281, comprising:
the peracid anion at a concentration in a range of from 6.5% (weight/volume) to 8.0% (weight/volume);
the 10-minute stability index (SI₁₀) being at least 0.88;
the concentration of dissolved hydrogen peroxide being no larger than 1200 mg/L; and
the pH being at least 12.2.

297. The composition of any one of paragraphs 203-296, comprising any of the composition properties recited in any of paragraphs 1-195.

### Other Combinations

401. A peracid salt-reactive oxygen species formulation capable of generating singlet oxygen, the peracid salt-reactive oxygen species formulation comprising a reacted mixture of alkali, hydrogen peroxide and an acyl donor;
wherein the peracid salt-reactive oxygen species formulation has a pH value from about pH 12.2 to about pH 13.5 and a peracid anion to peracid molar ratio from about 10,000:1 to about 40,000:1.

402. The peracid salt-reactive oxygen species formulation of paragraph 401, wherein the molar ratio of hydrogen peroxide to alkali in feed for the mixture is in a range of about 1:1.0 to about 1:1.2.

403. The peracid salt-reactive oxygen species formulation of either one of paragraph 401 or paragraph 402, comprising a molar ratio of hydrogen peroxide to acyl donor groups, preferably to acetyl donor groups, in feed for the mixture in a range of from about 1:1.0 to about 1:1.25, and preferably a narrower range disclosed herein.

404. The peracid salt-reactive oxygen species formulation of any one of paragraphs 401-403, wherein the acyl donor is an acetyl donor and the peracid salt reactive oxygen species formulation is a peracetate-reactive oxygen species formulation.

405. The peracid salt-reactive oxygen species formulation of any one of paragraphs 414, wherein the molar ratio of peracid anions, preferably peracetate anions, to hydrogen peroxide is greater than about 16:1.

406. The peracid salt-reactive oxygen species formulation of any one of paragraphs 415, comprising a concentration of peracid anion, preferably peracetate anion, of about 1.0% wt/volume or greater, and preferably about 2.0% wt/volume or greater.

407. The peracid salt-reactive oxygen species formulation of paragraph 416, wherein the concentration of peracid anion, and preferably peracetate anion, is up to about 8.0% wt/volume, and preferably in a range of from about 3.0% to about 8.0%.

408. The peracid salt-reactive oxygen species formulation of any one of paragraphs 401-417, comprising reaction byproducts from preparation of the peracid salt-reaction oxygen species of with triacetin as acetyl donor.

409. The peracid salt-reactive oxygen species formulation of any one of paragraphs 401-408, comprising hydrogen peroxide at a concentration of no greater than about 10 mg/L.

410. The peracid salt-reactive oxygen species formulation of any one of paragraphs 401-409, wherein the peracid salt-reactive oxygen species formulation is a peracetate-reactive oxygen species formulation comprising a TOC:peracetate anion mass ratio of less than 0.60.

411. A method for generating a peracid salt-reactive oxygen species formulation, optionally the peracid salt-reactive oxygen species formulation of any one of paragraphs 401-410, the method comprising:
mixing an alkali hydrogen peroxide solution with an acyl donor, preferably an acetyl donor, and reacting the mixture to prepare the peracid salt-reactive species formulation, and preferably a peracetate-reactive oxygen species formulation, at a PH in a range for from about pH 12.2 to about pH 13.5 and preferably at least pH 12.5 and more preferably from pH 12.5 to pH 12.8; and
wherein the alkali hydrogen peroxide solution, immediately prior to the mixing, has a molar ratio of hydrogen peroxide to alkali in a range of from about 1:0.8 to about 1.5, and preferably the molar ratio of hydrogen peroxide to alkali is not greater than 1:1.2 and more preferably not greater than 1.1.18, and with one preferred range for the molar ratio of hydrogen peroxide to alkali being from 1:1.0 to 1:1.2 and one more preferred range being from 1:1.0 to 1:1.18.

412. The method of paragraph 411, wherein the mixing comprises combining the hydrogen peroxide and the acyl donor, preferably acetyl donor, at a molar ratio of hydrogen peroxide to acyl donor groups, preferably acetyl donor groups, in a range of from about 1:1.0 to about 1:1.25, and preferably in an even narrower range as discloses herein.

413. The method of either one of paragraph 411 or paragraph 412, wherein chemical side reactions are reduced during the generating of the peracid salt-reactive oxygen species formulation.

414. The method of any one of paragraphs 411-413, wherein the generated formulations can be produced by batch, semi-continuous or continuous processing.

415. The method of any one of paragraphs 411-414, wherein the acyl donor is an acetyl donor, and preferably the acetyl donor is triacetin.

416. The method of any one of paragraphs 411-415, diluting the formulation to a point of use concentration having an extended oxidative activity time of up to 120 minutes.

417. The method of paragraph 16, wherein the point of use is sanitization.

418. The method of any one of paragraphs 411-417, wherein the formulation is added to media having a pH of about pH 12 or less.

419. The method of any one of paragraphs 411-418, wherein the formulation is added to an acidic media to increase oxidative activity from the formulation.

420. The method of any one of paragraphs 411-419, wherein the formulation is stable at about 20 C for about 10 minutes.

421. The method of any one of paragraphs 411-420, wherein the formulation has a TOC:peracid anion mass ratio in a range of from about 0.48 to about 0.58.

422. The method of any one of paragraphs 411-421, further comprising use of the formulation in water treatment, pulp treatment, microbial control and sanitization.

423. The peracid salt-reactive oxygen species formulation or method of any one of paragraphs 401-423, wherein the peracid salt-reactive oxygen species is an aqueous peracetate-reactive oxygen species formulation comprising:
a peracetate anion concentration of no greater than about 8.0% weight/volume and preferably no greater than about 6.0% weight/volume, with the peracetate anion concentration preferably being at least about 1.0% weight/volume and more preferably at least about 2.0% weight/volume, and even more preferably the peracetate anion concentration is in range of from about 3.0 to about 5.0% weight/volume;
a pH in a range of from about pH 12.2 to about pH 13.5, preferably at least pH 12.5 and more preferably from about pH 12.5 to about 12.8;
a peracetate anion to peracetic acid molar ratio in a range of from about 10,000:1 to about 40,000:1, and preferably at least about 18,000 and more preferably in a range of from about 18,000 to about 38,000;
optionally hydrogen peroxide, wherein a molar ratio of peracetate anions to hydrogen peroxide in the peracetate-reactive oxygen species formulation is greater than about 16:1.

424. The peracid salt-reactive oxygen species formulation or method of paragraph 423, wherein the peracetate-reactive oxygen species formulation comprises total organic carbon (TOC) at a TOC:peracetate anion mass ratio of no greater than 0.60, preferably less than 0.60, more preferably no greater than 0.59 and even more preferably no greater than 0.58.

425. The peracid salt-reactive oxygen species formulation of paragraph 424, wherein the TOC:peracetate anion mass ratio is at least 0.48.

426. The peracid salt-reactive oxygen species formulation or method of any one of paragraphs 23-25, wherein the peracetate-reactive oxygen species formulation comprises a concentration of hydrogen peroxide of no larger than 1500 mg/L, and preferably no larger than 750 mg/L and even more preferably no larger than 400 mg/L, and still more preferably no larger than 10 mg/L

427. A method of oxidative treatment of a substrate, comprising contacting the substrate with a formulation selected from the group consisting of a peracid salt-reactive oxygen species formulation, preferably a peracetate-reactive oxygen species formulation, according to any one of paragraphs 1-26 and a diluted formulation prepared by diluting a peracid salt-reactive oxygen species formulation, preferably a peracetate-reactive oxygen species formulation, according to any one of paragraphs 401-26.

428. The method of paragraph 427, comprising contacting the substrate with the peracid salt-reactive oxygen species formulation and wherein the contacting occurs within 10 minutes after preparation of the peracid salt-reactive oxygen species formulation.

429. A method of paragraph 427, comprising contacting the substrate with the diluted formulation and wherein the contacting occurs within 120 minutes following preparation of the peracid salt-reactive oxygen species formulation.

430. A method of any one of paragraphs 427-429, wherein the substrate comprises a surface of a solid object, and optionally to sanitize the surface.

431. A method of any one of paragraphs 427-429, wherein the substrate comprises a water to be treated.

432. A method of any one of paragraphs 427-429, wherein the substrate comprises a pulp slurry with pulp to be oxidatively treated to delignify and/or bleach the pulp.

The foregoing description of the present invention and various aspects thereof has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain known modes of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

The description of a feature or features in a particular combination do not exclude the inclusion of an additional feature or features in a variation of the particular combination. Processing steps and sequencing are for illustration only, and such illustrations do not exclude inclusion of other steps or other sequencing of steps to an extent not necessarily incompatible. Additional steps may be included between any illustrated processing steps or before or after any illustrated processing step to an extent not necessarily incompatible.

The terms “comprising”, “containing”, “including” and “having”, and grammatical variations of those terms, are intended to be inclusive and nonlimiting in that the use of such terms indicates the presence of a stated condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of” or “consisting of” or “consisting of only” (or any appropriate grammatical variation of such narrower terms). For example, a statement that something “comprises” a stated element or elements is also intended to include and disclose the more specific narrower embodiments of the thing “consisting essentially of” the stated element or elements, and the thing “consisting of” the stated element or elements. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” means all or a portion that is less than all. The term “at least a part” means all or a part that is less than all.

1. A method for preparing a nonequilibrium peracid salt composition to use to generate singlet oxygen during oxidative treatments, the method comprising:
reacting components in an aqueous reaction mixture prepared from a combination of chemical feedstocks to form an aqueous nonequilibrium peracid salt composition, the chemical feedstocks comprising acyl donor with acyl donor groups, hydrogen peroxide and alkali metal hydroxide in amounts and proportions, including to account for yield losses, to prepare the nonequilibrium peracid salt composition with composition properties comprising:
dissolved peracid anion of the peracid salt at a concentration in a range of from 1.0% (weight/volume) to 8.0% (weight/volume); and
pH in a range of from pH 12.0 to pH 13.5; and
wherein the combination of reaction feedstocks comprises:
a first molar ratio of the alkali metal hydroxide to the acyl donor groups in a range of from 1.00 to 1.40; and
a second molar ratio of hydrogen peroxide to the acyl donor groups in a range of from 0.80 to 1.00; and
continuing the reacting at least until the nonequilibrium peracid salt composition is prepared including the composition properties.

2. The method of claim 1, wherein the first molar ratio is in a range of from 1.05 to 1.30.

3. The method of claim 2, wherein the pH is in a range of from 12.5 to 13.2.

4. The method of claim 3, wherein the composition properties comprise a concentration of dissolved hydrogen peroxide of no larger than 1400 mg/L.

5. The method of claim 1, wherein the composition properties comprise a molar ratio of dissolved hydrogen peroxide to the peracid anion of no larger than 1/10.

6. The method of claim 1, wherein the composition properties comprise a 10-minute stability index (SI₁₀) at a temperature of 22° C. of at least 0.80, wherein the 10-minute stability index is calculated according to Equation I:
$$S {I}_{10} = C {A}_{10} / {CA}_{0} \qquad Equation I$$
wherein:
SI₁₀ is the 10-minute stability index;
CA₀ is the concentration (% weight/volume) of the peracid anion determined for a first time; and
CA₁₀ is a concentration (% weight/volume) of the peracid anion determined for a second time corresponding to 10 minutes following the first time.

7. (canceled)

8. The method of claim 6, wherein the composition properties comprise a 30-minute stability index (SI₃₀) at a temperature of 22° C. of at least 0.65, wherein the 30-minute stability index is calculated according to Equation II:
$${SI}_{30} = C {A}_{30} / {CA}_{0} \qquad Equation II$$
wherein:
SI₃₀ is the 30-minute stability index; and
CA₀ is the concentration (% weight/volume) of the peracid anion determined for a first time; and
CA₃₀ is a concentration (% weight/volume) of the peracid anion determined for a third time corresponding to 30 minutes following the first time;
and wherein the 30-minute stability index is smaller than the 10-minute stability index by at least 0.05.

9-12. (canceled)

13. The method of claim 3, wherein the composition properties comprise a weight ratio of total organic carbon to the peracid anion of no larger than 0.58.

14-16. (canceled)

17. The method of claim 3, wherein the acyl donor is an acetyl donor; the nonequilibrium peracid salt composition is a nonequilibrium peracetic acid salt composition, and the peracid anion is peracetate.

18. The method of any one of claim 3, wherein the composition properties comprise the peracid anion at a concentration of at least 2.0% (weight/volume).

19. The method of any one of claim 1, wherein:
the first molar ratio is in a range of from 1.05 to 1.30;
the second molar ratio is in a range of from 0.87 to 1.00;
the composition properties comprise;
the peracid anion at a concentration in a range of from 3.0% (weight/volume) to 6.5% (weight/volume);
a concentration of hydrogen peroxide of no larger than 1200 mg/L; and
a pH of at least 12.4.

20-22. (canceled)

23. The method of claim 1, wherein the combination of reaction feedstocks comprises a third molar ratio of the alkali metal hydroxide to hydrogen peroxide in a range of from 1.00 to 1.63.

24. A nonequilibrium peracid salt composition made by the process of claim 17.

25. A method of oxidative treatment of a substrate, comprising:
preparing by the method of claim 1 a nonequilibrium peracid salt composition; and
contacting a substrate with the nonequilibrium peracid salt composition.

26. The method of claim 25, wherein the substrate comprises an aqueous liquid at a pH at least two pH units smaller than the pH of the nonequilibrium peracid salt composition immediately prior to the contacting.

27. The method of claim 26, wherein the substrate comprises a slurry comprising the aqueous liquid and pulp to be oxidatively treated to delignify and/or bleach the pulp.

28. A method of oxidative treatment of a substrate, comprising:
preparing by the method of claim 1 a nonequilibrium peracid salt composition;
diluting the nonequilibrium peracid salt composition to prepare a diluted nonequilibrium peracid salt composition; and
contacting a substrate with a diluted nonequilibrium peracid salt composition.

29. The method of claim 28, wherein the substrate comprises a surface of a solid object to be sanitized.

30-31. (canceled)

32. An aqueous, nonequilibrium peracid salt composition for generation of singlet oxygen for use in oxidative treatments, the composition comprising:
dissolved peracid anion of an alkali metal salt of a peracid at a concentration in a range of from 1.0% (weight/volume) to 8.0% (weight/volume);
pH in a range of from pH 12.0 to pH 13.5;
a concentration of dissolved hydrogen peroxide of no more than 1400 mg/L;
a 10-minute stability index (SI₁₀) at a temperature of 22° C. of at least 0.80, wherein the 10-minute stability index is calculated according to Equation I:
$$S {I}_{10} = C {A}_{10} / {CA}_{0} \qquad Equation I$$
wherein:
SI₁₀ is the 10-minute stability index;
CA₀ is the concentration (% weight/volume) of the peracid anion determined for a first time; and
CA₁₀ is a concentration (% weight/volume) of the peracid anion determined for a second time corresponding to 10 minutes following the first time.

33-36. (canceled)

37. The composition of claim 32, comprising a 30-minute stability index (SI₃₀) at a temperature of 22° C. of at least 0.65, wherein the 30-minute stability index is calculated according to Equation II:
$${SI}_{30} = C {A}_{30} / {CA}_{0} \qquad Equation II$$
wherein:
SI₃₀ is the 30-minute stability index; and
CA₀ is the concentration (% weight/volume) of the peracid anion determined for a first time; and
CA₃₀ is a concentration (% weight/volume) of the peracid anion determined for a third time corresponding to 30 minutes following the first time;
and wherein the 30-minute stability index is smaller than the 10-minute stability index by at least 0.05.

38-43. (canceled)
